(19) United States
(12) Patent Application Publication
(10) Pub. No.: US 2026/0148580 A1
(43) Pub. Date: May 28, 2026

(54) DRAWING WORK SUPPORT SYSTEM

(71) Applicant: Hitachi, Ltd., Tokyo (JP)

(72) Inventors: Shoji YAMAMOTO, Tokyo (JP); Shingo HAYASHI, Tokyo (JP); Masahiko NIIOKA, Tokyo (JP); Tomoki TACHIKAWA, Tokyo (JP)

(21) Appl. No.: 19/303,795

(22) Filed: Aug. 19, 2025

(30) Foreign Application Priority Data
Nov. 27, 2024 (JP) 2024-206158

(51) Int. Cl. G06V 30/422; G06T 11/20

(52) U.S. Cl. CPC G06V 30/422; G06T 11/23; G06T 11/26

(57) ABSTRACT

The drawing work support system according to the present invention generates information on a connection between wiring and a drawing symbol in a drawing, extracts the wiring or the drawing symbol as a start-and-end point element representing a start point or an end point of the connection, discriminates the start point and the end point from the start-and-end point element, and extracts a path between the start point and the end point.

### CROSS-REFERENCE TO RELATED APPLICATION

This application claims the priority of Japanese Patent Application No. 2024-206158 filed on Nov. 27, 2024, which is incorporated herein by reference in its entirety.

### BACKGROUND OF THE INVENTION

### 1. Field of the Invention

The present invention relates to a system that supports drawing work using a portable terminal.

### 2. Description of the Related Art

In recent years, digitization at a maintenance work site has accelerated, and work performed using a portable terminal for inputting work information has become widespread instead of work performed using conventional paper. In work using drawings that include electrical connection information of circuits or the like, tracing work is recorded by being written by hand on wiring or on drawing symbols. In order to digitize this work, it is possible to grasp whether or not each element has been checked by performing an analysis within the drawing to extract the elements, namely, character strings, wiring, and drawing symbols, and by collating the coordinates of the extracted elements with the handwritten point cloud coordinates. From the results of checking elements, work progress can be confirmed and appropriate work support from an administrator to a portable terminal of a worker can be provided (for example, optimal procedures corresponding to any omissions and checking stage can be presented).

JP 2022-162482 A describes a technique in which a paper drawing is read by a scanner and character strings and wiring information are extracted to search for the wiring desired by a worker. JP 2007-293589 A describes a technique for searching for the shortest path between a start point and an end point by making a manual selection of elements at the start point and the end point via a GUI.

### SUMMARY OF THE INVENTION

In the prior art, a start point and an end point are manually designated, and only one path for the shortest path between the start point and the end point is generated. However, in a maintenance operation, it is necessary to check all wiring between the start point and the end point and the drawing symbols, and therefore it is necessary to generate all paths between the start point and the end point. In addition, where conventional methods for designating a start point and an end point for each work item are concerned, in a case where there are many combinations between the start point and the end point, it takes time to perform the designations manually.

The present invention was conceived of in view of the above problems, and an object of the present invention is to automatically extract, from a drawing, a start point and an end point and all the paths between the start point and the end point in a case where work is supported by displaying the drawing on a work terminal.

The drawing work support system according to the present invention generates information on a connection between wiring and a drawing symbol in a drawing, extracts the wiring or the drawing symbol as a start-and-end point element representing a start point or an end point of the connection, discriminates the start point and the end point from the start-and-end point element, and extracts a path between the start point and the end point.

With the drawing work support system of the present invention, work efficiency can be improved by automatically generating a start point, an end point, and a work path. In addition, because it is possible to grasp to what extent the work has been completed on all the work paths between the start point and the end point, it is possible to manage progress in units of work.

### BRIEF DESCRIPTION OF THE DRAWINGS

FIG. 1A is a diagram showing a work record of maintenance and inspection work using a drawing;

FIG. 1B is a diagram showing a work record of maintenance and inspection work using a drawing;

FIG. 2 is a diagram showing an analysis result after collation between handwriting and element coordinates;

FIG. 3 is a configuration diagram of a drawing work support system 100 according to a first embodiment.

FIG. 4A illustrates character registration information;

FIG. 4B illustrates wiring registration information;

FIG. 4C illustrates drawing symbol registration information;

FIG. 5A is a diagram showing a method for detecting a power source;

FIG. 5B is a diagram showing a method for detecting a power source;

FIG. 6A is a diagram illustrating the concept of function block detection;

FIG. 6B is a diagram illustrating the concept of function block detection;

FIG. 7A is a diagram illustrating the concept of load detection;

FIG. 7B is a diagram illustrating the concept of load detection;

FIG. 8A is an example of a ladder diagram;

FIG. 8B is a flowchart illustrating a procedure for detecting start-and-end point elements in the ladder diagram;

FIG. 9A is an example of an FBD;

FIG. 9B is a flowchart illustrating a procedure for detecting start-and-end point elements in the FBD;

FIG. 10A is an example of an SFC;

FIG. 10B is a flowchart illustrating a procedure for detecting start-and-end point elements in the SFC;

FIG. 11 is a diagram showing a table of start-and-end point elements 154 in a database 150;

FIG. 12A is a diagram illustrating a method for extracting a path between a start point and an end point;

FIG. 12B is a diagram illustrating a method for extracting a path between a start point and an end point;

FIG. 12C is a diagram illustrating a method for extracting a path between a start point and an end point;

FIG. 13A is a configuration diagram of a drawing work support system 100 according to a second embodiment;

FIG. 13B is a configuration diagram of the drawing work support system 100 according to the second embodiment;

FIG. 13C is a configuration diagram of the drawing work support system 100 according to the second embodiment;

FIG. 14A is a diagram showing the role of link symbols;

FIG. 14B is a diagram showing the role of link symbols;

FIG. 15A is a diagram showing wiring and drawing symbols in the vicinity of link symbols;

FIG. 15B is a flowchart illustrating a procedure for extracting link symbols;

FIG. 15C is a diagram showing a database of link symbols 156;

FIG. 16A shows a page where a start point is present;

FIG. 16B shows a page where an end point is present;

FIG. 16C shows a database of paths after the generation of start-and-end point combinations;

FIG. 17A is a diagram illustrating the operation of a start-and-end point path extraction unit 140 in a case where the start point and the end point are present in the same page;

FIG. 17B is a diagram illustrating the operation of the start-and-end point path extraction unit 140 in a case where the start point and the end point are present in the same page;

FIG. 18A is a diagram illustrating the operation of the start-and-end point path generation unit in a case where the start point and the end point are present on different pages;

FIG. 18B is a diagram illustrating the operation of the start-and-end point path generation unit in a case where the start point and the end point are present on different pages;

FIG. 19A is a configuration diagram of a drawing work support system 100 according to a third embodiment;

FIG. 19B is a configuration diagram of the drawing work support system 100 according to the third embodiment;

FIG. 19C is a configuration diagram of the drawing work support system 100 according to the third embodiment;

FIG. 20 is a diagram showing an example in which work support content is displayed on a portable terminal 300;

FIG. 21 illustrates an example in which an analysis result of the work unit analysis unit 160 is displayed on a display unit 400;

FIG. 22A is a diagram showing utilization of a work record for a handover function at the time of drawing replacement; and

FIG. 22B is a diagram showing utilization of a work record for a handover function at the time of drawing replacement.

### DESCRIPTION OF THE PREFERRED EMBODIMENTS

### First Embodiment

In a first embodiment of the present invention, maintenance and inspection work using a portable terminal (work terminal) and an analysis result thereof will be described. First, maintenance and inspection work using a portable terminal will be described.

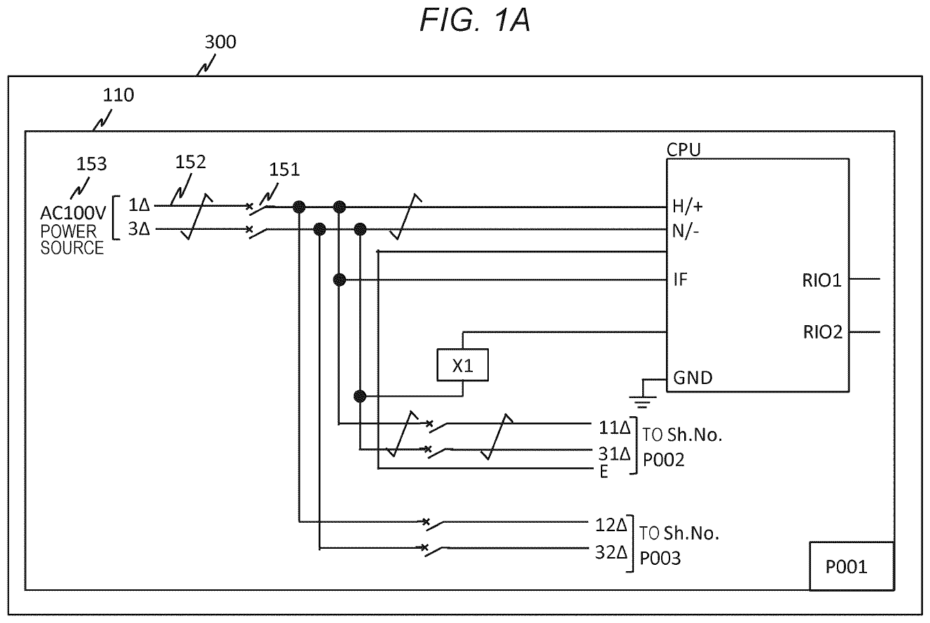

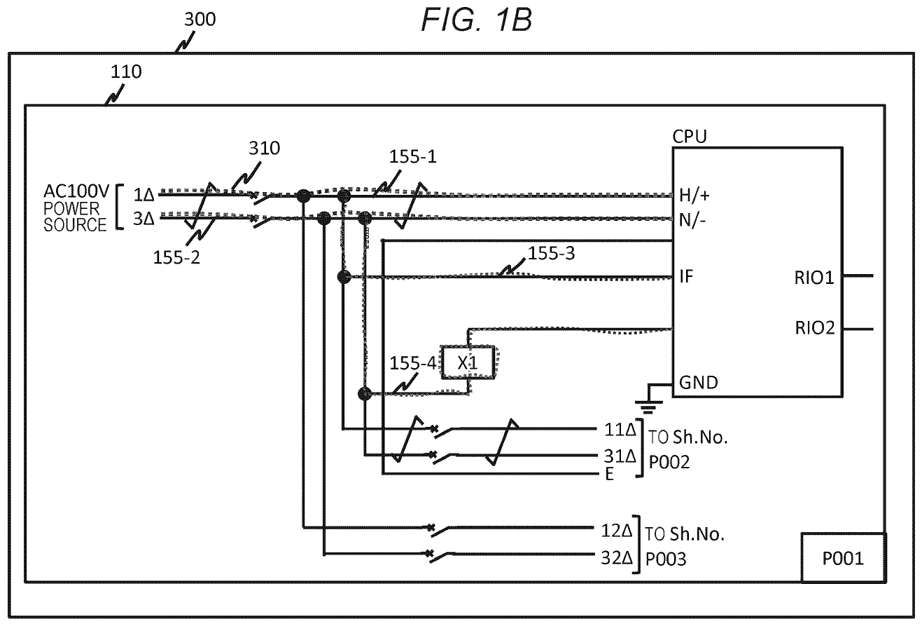

FIGS. 1A to 1B are diagrams showing work records of maintenance and inspection work using a drawing. FIG. 1A shows a drawing of interest. FIG. 1B is a diagram showing a handwritten work record on a target drawing. Drawing 110 in FIG. 1A is displayed on the portable terminal 300 and includes elements which are a drawing symbol 151, wiring 152, and a character 153. Although only some representative elements are numbered in FIG. 1A, the drawing symbol 151, the wiring 152, and the character 153 may all include a plurality of elements.

In the maintenance and inspection work using the portable terminal 300, for example, electrical measurement of voltage, resistance, and the like using a tester is performed, and the work of tracing the confirmed drawing symbol 151 and wiring 152 by hand is performed. FIG. 1B illustrates a work example of confirming the connection from an AC 100V power source to the CPU, and illustrates the result of the work of tracing the confirmed drawing symbol 151 and wiring 152 by the handwriting 310 indicated by the dotted lines. In this work, it is necessary to paint all the drawing symbols 151 and wiring 152 connected between the AC 100V power source and the CPU. In the present invention, an AC 100V power source is referred to as a start point, a CPU is referred to as an end point, and the connection from the start point to the end point passing through the drawing symbol 151 and the wiring 152 is referred to as a path. In the work example, there are four paths 155-1 to 155-4, and it is necessary to paint four paths with handwriting 310 in order to complete this work.

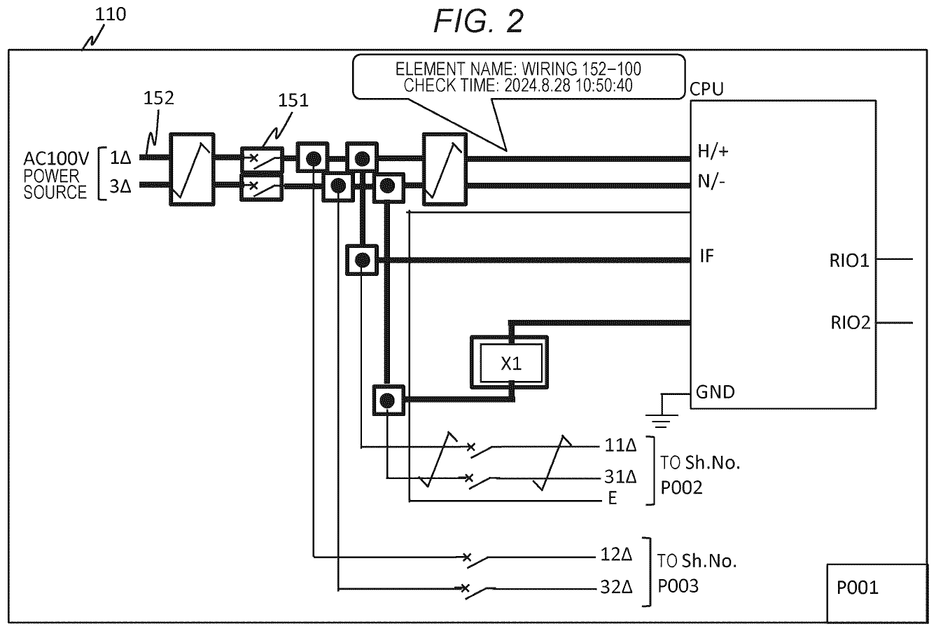

FIG. 2 is a diagram showing an analysis result after collation between handwriting and element coordinates. FIG. 2 illustrates the result of determining whether or not the point cloud coordinate data of the handwriting 310 has been checked by comparing the point cloud coordinate data with the coordinate regions of the drawing symbols 151 and the wiring 152. The drawing symbols 151 which have been determined as checked are indicated by a thick frame, and the wiring 152 is indicated by a thick line. By analyzing the work record performed between the start point and the end point in this manner, it is possible to confirm whether or not all the paths between the start point and the end point have been checked, thus making it possible to determine whether or not the confirmation work between the start point and the end point has been completed. In this example, completion of the confirmation work between the start point and the end point enables progress management of completion of the confirmation of the power source line between the AC 100V power source and the CPU. In addition, because a check time can be assigned to each element in this analysis, it is possible to utilize not only the presence or absence of element checking but also the work process of the checking order.

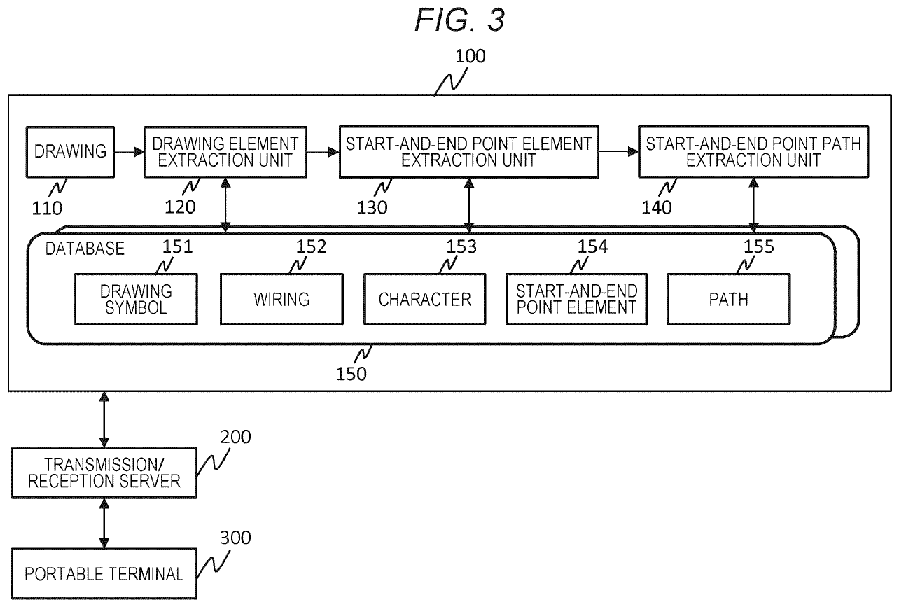

FIG. 3 is a configuration diagram of a drawing work support system 100 according to the first embodiment of the present invention. The drawing work support system 100 is connected to the portable terminal 300 used by a worker via a transmission/reception server 200. The drawing work support system 100 exchanges data such as files with the portable terminal 300 via the transmission/reception server 200. The drawing work support system 100 includes the drawing 110, a drawing element extraction unit 120, start-and-end point element extraction unit 130, a start-and-end point path extraction unit 140, and a database 150. The database 150 stores drawing symbols 151, wiring 152, characters 153, start-and-end point elements 154, and paths 155. The database 150 exists for each drawing, and each database 150 has the drawing symbols 151, the wiring 152, the characters 153, the start-and-end point elements 154, and the paths 155.

Taking the drawing 110 as an input, the drawing element extraction unit 120 analyzes the inside of the drawing 110, extracts drawing symbols 151, wiring 152, and characters 153, and registers these elements in the database 150. As an extraction method, any method such as a method for obtaining information obtained by decoding a drawing or a method for obtaining information through image analysis can be used.

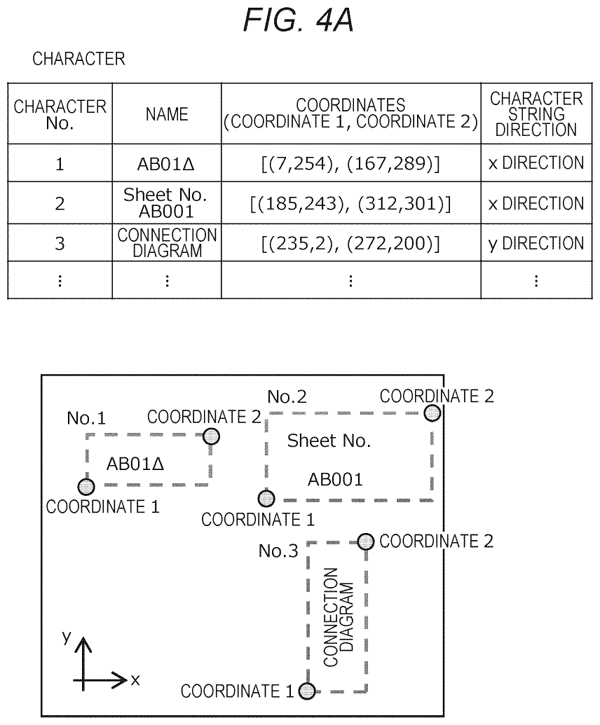

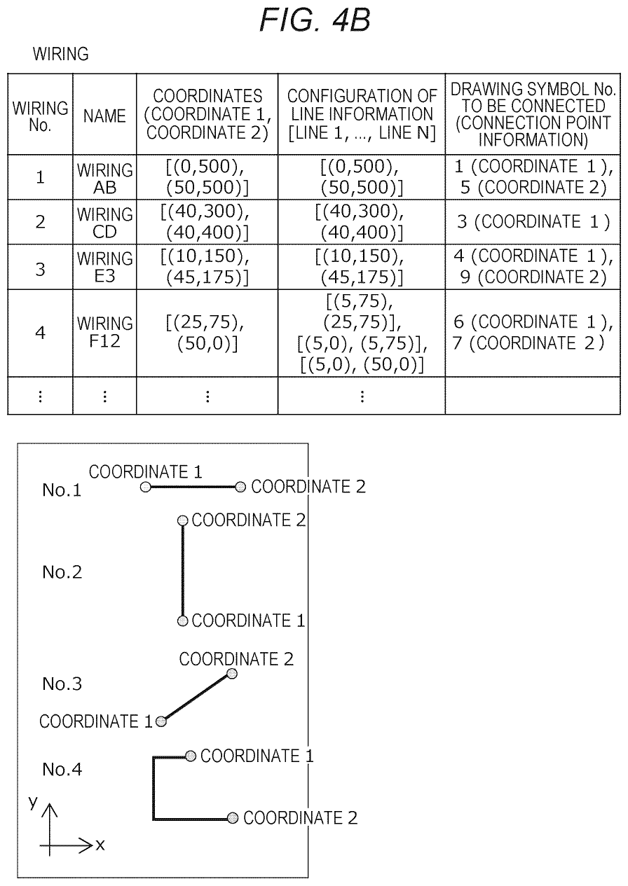

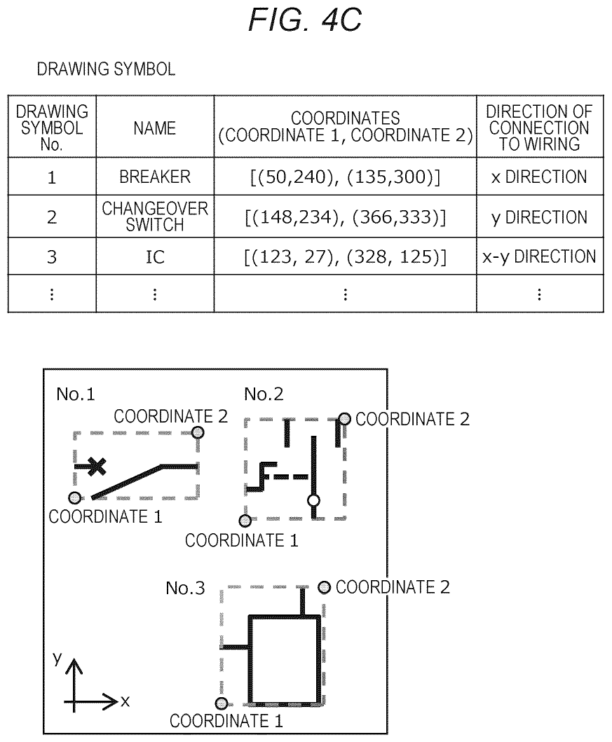

FIGS. 4A to 4C are diagrams showing registration information of characters, wiring, and drawing symbols in the database 150. FIG. 4A illustrates character registration information, FIG. 4B illustrates wiring registration information, and FIG. 4C illustrates drawing symbol registration information.

Characters include character numbers that are incremented in order of detection, names, coordinates representing bounding boxes, and the directions of character strings. Wiring includes wiring numbers incremented in order of detection, names, coordinates representing end points of the wiring, end points of coordinates of a plurality of pieces of wiring in a case where a plurality of pieces of wiring are connected, and drawing symbol Nos. connected to the end points of the wiring. The drawing symbol No. connected to a wiring end point has information indicating which of the coordinates 1 and 2 each drawing symbol No. is connected to. As the drawing symbol No. to be connected, two drawing symbols Nos. are described in the case of connection on both sides of the wiring, and one drawing symbol No. is described in the case of one side being open. Drawing symbols include drawing symbol Nos. incremented in order of detection, names, coordinates representing bounding boxes, and directions of connections with wiring.

The start-and-end point element extraction unit 130 extracts start-and-end point elements 154 as start and end points from the drawing symbols 151, the wiring 152, and the characters 153 which have been output by the drawing element extraction unit 120, and registers the start-and-end point elements in the database 150. The start-and-end point path extraction unit 140 extracts the paths 155 between the start and end points from the start-and-end point elements 154 and registers the paths in the database 150.

Hereinafter, the specific method of extraction by the start-and-end point element extraction unit and the start-and-end point path extraction unit of the present invention will be described. First, the specific extraction method for extracting the start-and-end point elements of the start-and-end point element extraction unit will be described. Because the start-and-end point elements 154 vary depending on the type of drawing, in the present invention, a ladder diagram, a function block diagram (hereinafter, FBD), and a sequential function chart (hereinafter, SFC), which are representative drawings using PLC language, will be described in addition to an elementary wiring diagram.

First, a elementary wiring diagram will be described. In the elementary wiring diagram, the elements serving as the start-and-end point elements are three elements, namely, a power source, a function block such as a CPU, and a load.

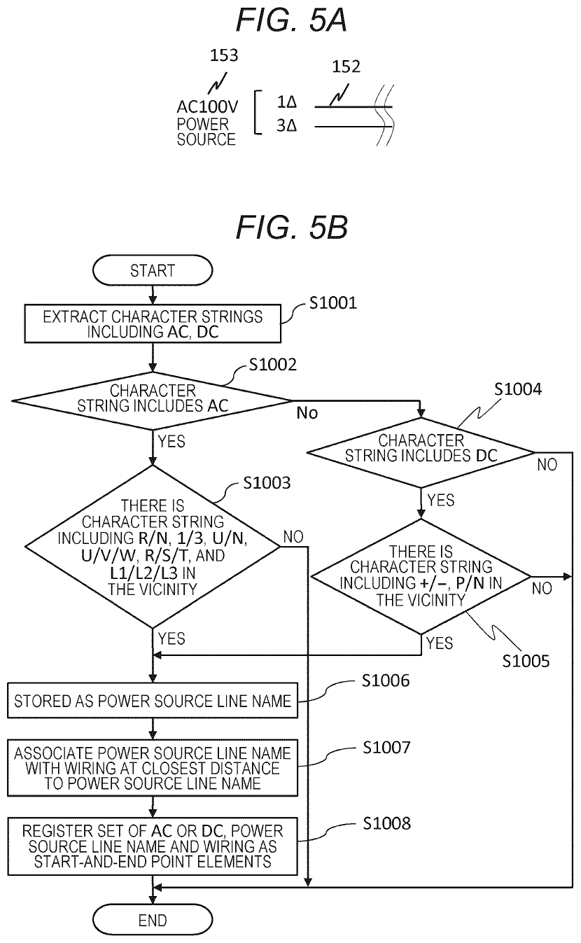

FIGS. 5A to 5B are diagrams showing a method for detecting a power source; FIG. 5A is a diagram obtained by cutting out only a power source section, and FIG. 5B is a diagram showing a flow for extracting the power source.

The concept of power source detection will be described. The power source is roughly divided into AC (alternating current) and DC (direct current), and there is a power source line (wiring 152 in FIG. 5A) near characters including “AC” and “DC” on drawing 110 (character 153 in FIG. 5A). The power source line has a name. In AC, generally, R/N, 1/3 (denoted 1Δ, 3Δ in FIG. 5A), and U/N are attached to the head in the case of a single phase, and U/V/W and R/S/T are attached to the head in the case of three phases, or denoted as L1/L2/L3 in many cases. In DC, + and − are added to denote names such as V+/V−, and P and N are added to denote names such as P24 and N24 in many cases. The power source is detected by finding such a power source line name and associating the power source line name with the wiring.

FIG. 5B is a flowchart illustrating a procedure for detecting a power source, and is performed by the drawing element extraction unit 120. First, character strings including AC or DC are extracted (S1001). In a case where the character string includes AC (S1002: YES), it is determined whether there is a character string including any one of R/N, 1/3, U/N, U/V/W, R/S/T, and L1/L2/L3 in the vicinity (S1003). In a case where the character string includes DC instead of AC (S1002: NO, S1004: YES), it is determined whether there is a character string including either +/− or P/N in the vicinity (S1005). If there is a corresponding character string in S1003 or S1005, the drawing element is stored as the power source line name (S1006). Next, the power source line name and wiring having the closest distance to the power source line name are searched for, and the wiring and the power source line name thus found are associated with each other (S1007). The extracted character strings including AC and DC, the power source line name, the power source line name, and the associated wiring are registered as a power source list in the start-and-end point elements 154 in the database 150 (S1008).

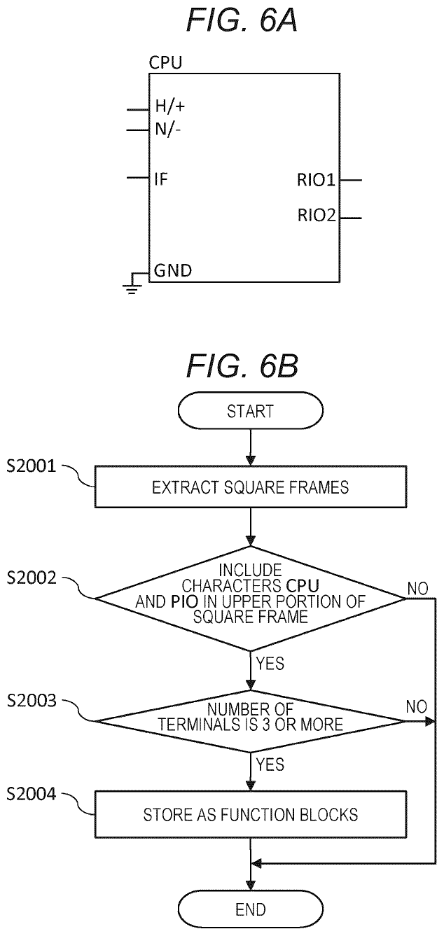

FIGS. 6A to 6B are diagrams illustrating the concept of function block detection. function blocks mainly include square frames, names, and terminals. Names are names with functions, and include, for example, a central processing unit (CPU) having the control function illustrated in FIG. 6A, a programmed input/output (PIO) having an interface function between the CPU and peripheral devices, and the like, as part of the name. The terminals are characterized in that there are at least three terminals, including terminals for a power source (at least two terminals for single-phase) and for a signal IF. Therefore, a function block is defined by including a name that includes the function on a square frame, and including three or more terminals, and detection is performed according to this definition.

FIG. 6B is a flowchart illustrating a procedure for detecting a function block, and is performed by the drawing element extraction unit 120. First, square frames are extracted (S2001). In square frame extraction, a size may be designated. For example, function blocks that are too large to be a function block, such as the outer frame in drawing 110, and very small squares are excluded. Next, the characters at the top of the square frame are extracted, and it is determined whether the characters of CPU and PIO are included (S2002). Although the characters are designated as CPU and PIO, character strings are not limited to CPU and PIO and can be added to the determination as long as the character strings indicate functions. Next, it is determined whether the number of terminals is 3 or more (S2003). If the number of terminals is 3 or more, function block targets are registered as function blocks in the start-and-end point elements 154 in the database 150.

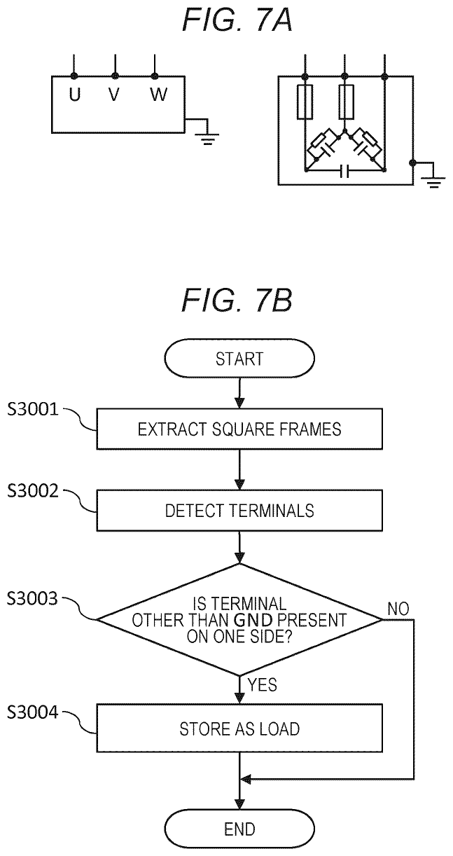

FIGS. 7A to 7B are diagrams illustrating the concept of load detection. A load is characterized by being at a terminal portion of wiring, and all pieces of wiring connected to terminals other than GND are oriented in the same direction. In the drawing representing the load, pieces of wiring are arranged in one direction on a square frame, and there is a GND terminal. In the example of FIG. 7A, three terminals are arranged on the upper side of the square frame, and the pieces of wiring are connected from the upper side. For example, the load on the left of FIG. 7A is a three-phase motor, and the load on the right of FIG. 7A is a phase compensator. Therefore, it is possible to determine whether a function block is a load from the arrangement of the square frame and the terminals.

FIG. 7B is a flowchart illustrating a procedure for detecting a load, and is performed by the drawing element extraction unit 120. First, square frames are detected (S3001). Next, terminals connected to the square frames are detected (S3002). It is determined whether a terminal other than GND is present on one side, that is, whether the y coordinates of the terminals are the same (S3003). If the determination is true, the terminal is registered as a load in the start-and-end point elements 154 in the database 150 (S3004).

Next, a ladder diagram, a function block diagram (hereinafter, FBD), and a sequential function chart (hereinafter, SFC), which are representative diagrams using PLC language, will be described.

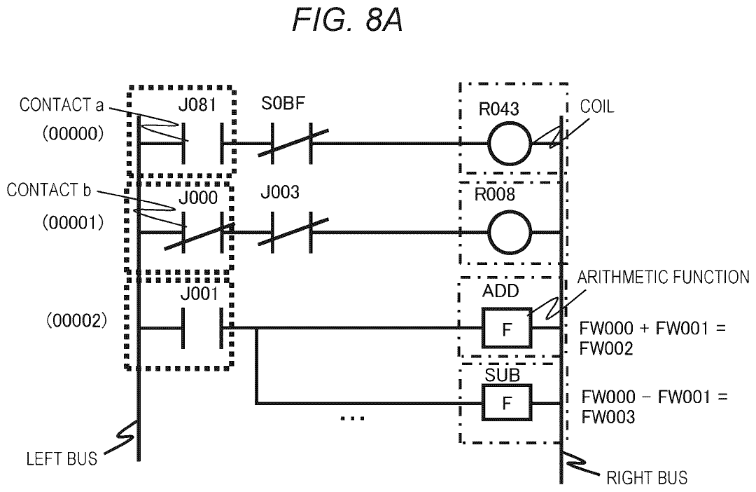

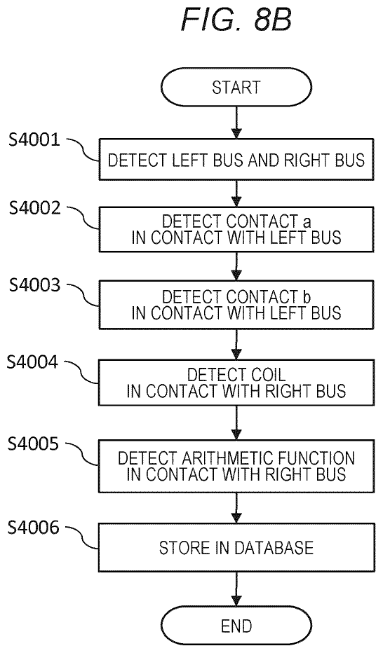

FIG. 8A is an example of a ladder diagram. The ladder diagram includes a contact condition and a command sandwiched between a left bus and a right bus. Circuit numbers indicating one execution unit are described on the left side of the left bus, and each circuit number has a function. For example, in the circuit number (0000), when the contact a of J081 is ON and the contact b of S0BF is OFF, the output of coil R043, which is the output, becomes high. Arithmetic functions which are the function execution blocks ADD and SUB connected to the right bus of the circuit number (0002) are executed when the contact a of J001 is turned ON. ADD, which is an addition function, executes FW000+FW001 and performs storage to FW002. SUB, which is a subtraction function, executes FW000−FW001 and performs storage to FW003. In the ladder diagram, contact a or contact b connected to the left bus is a start flag, and an element surrounded by a dotted frame on the left bus is a start point element. In addition, the coil and arithmetic functions connected to the right bus serve as execution units, and an element surrounded by a one-dot chain line on the right bus serves as an end point element. Therefore, it is necessary to perform processing to detect contact a, contact b, the coil, and the arithmetic functions and to register the contact a, the contact b, the coil, and the arithmetic functions as start-and-end point elements.

FIG. 8B is a flowchart illustrating a procedure for detecting start-and-end point elements in a ladder diagram, and is performed by the start-and-end point element extraction unit 130. First, a left bus and a right bus are detected (S4001). Among the vertical lines in drawing 110, the two vertical lines which are the longest and of the same length may be detected as the respective buses. Among the buses, the bus with the smaller x-coordinate is defined as the left bus, and the bus with the larger x-coordinate is defined as the right bus. Next, contact a is detected (S4002). A characteristic of contact a is that vertical lines at close distances are parallel, the y coordinates of end points of the vertical lines coincide with each other, and horizontal lines intersect on both sides of the parallel vertical lines. Further, it is determined whether one end of the horizontal line connected on the left side of the vertical lines is in contact with the left bus. In the case of contact, the point of contact is considered to be contact a. Next, contact b is detected (S4003). Contact b is detected using a feature where an oblique line oriented upward to the right crosses the contact a. Next, the coil on the output side is detected (S4004). First, a circular shape is detected, and in a case where characters such as S (set coil) or R (reset coil) are present in the circle, the characters are simultaneously detected. Next, arithmetic functions are detected (S4005). The arithmetic functions are detected by the characteristic that there are characters in a square frame. Examples of characters include F, T (on-delay timer), C (counter), and U (one-shot timer) illustrated in FIG. 8A. Finally, the contact a, contact b, coil, and arithmetic functions are registered as the start-and-end point elements 154 in the database 150 (S4006).

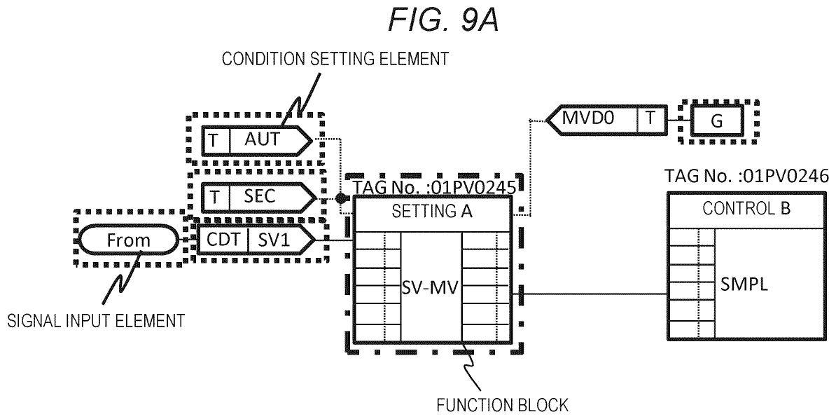

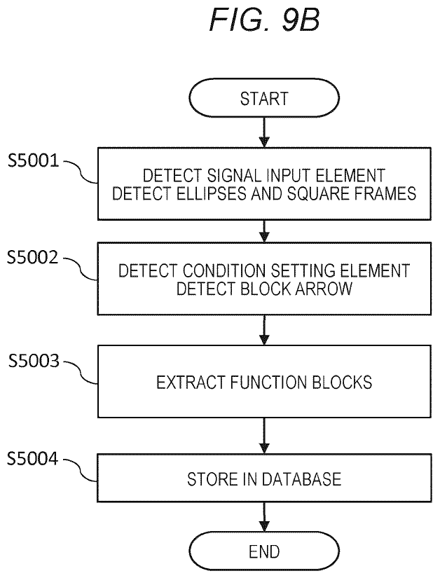

FIG. 9A is an example of an FBD. The FBD includes a function block and a plurality of input elements. Input elements include ellipses including characters for inputting a signal, squares including characters and block arrows including characters for setting a condition for a function block. The function blocks connect wiring between the next function blocks and transfer an output result. In FIG. 9A, an element in a dotted line frame is a start point element, and an element in a chain line frame is an end point element.

FIG. 9B is a flowchart illustrating a procedure for detecting start-and-end point elements in the FBD and is implemented by the start-and-end point element extraction unit 130. First, in order to detect a signal input element, an ellipse and a square frame are detected (S5001). The ellipses are detected by two horizontal lines being parallel to each other, the x coordinates of the end points of the horizontal lines coincide with each other, and the end points of the parallel horizontal lines being connected to semicircles. In addition, characters included in the ellipse are detected. The characters include “to” and “from”. Next, a square frame is detected. Characters included in the square frame include G. In addition, it is determined whether the number of pieces of wiring connected to the ellipse or the square frame is one. In a case where the number of wiring is one, it is detected as a signal input element. Next, in order to detect a condition setting element, a block arrow is detected (S5002). The block arrow is detected by the fact that two horizontal lines are parallel and the x coordinates of the end points of the horizontal lines coincide with each other, and the ends of the horizontal lines are connected by a vertical line and the other ends are connected by two oblique lines. In addition, the block arrow includes characters related to function setting, and AUT or the like representing automatic processing is included in FIG. 9A. In addition, it is determined whether there is one piece of wiring connected to the block arrow. In a case where there is one piece of wiring, it is detected as a condition setting element. Next, a function block is extracted (S5003). The function block has an input on the left side of the square frame and an output on the right side. The input side and output side are divided into a plurality of blocks, and enable a plurality of signals to be input and output. A module name is included in the center of the square frame, and a service name is included in the upper portion thereof. When a square frame is detected, the square frame is detected as a function block if a table is included in the square frame, wherein five cells are included in the column direction thereof, and two or more cells are included in the row direction thereof. Finally, the signal input element, the condition setting element, and the function block are registered in the start-and-end point elements 154 in the database 150 (S5004).

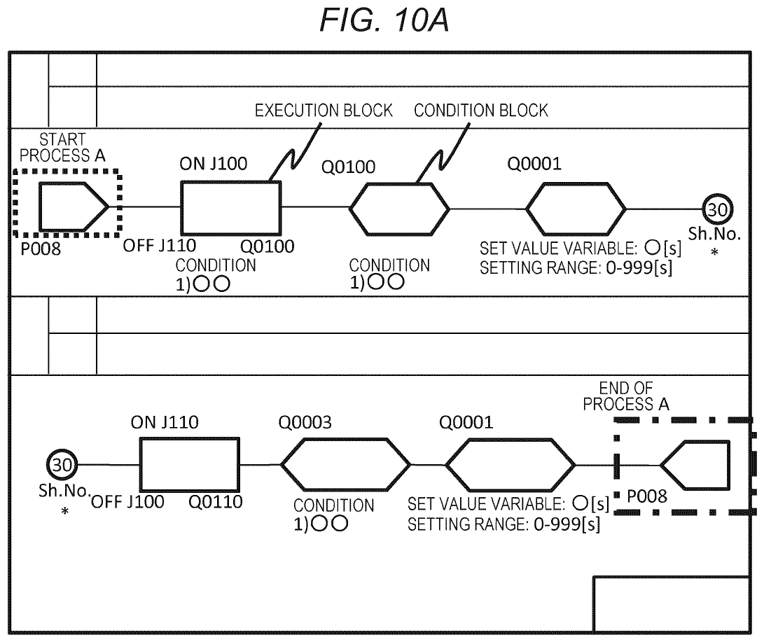

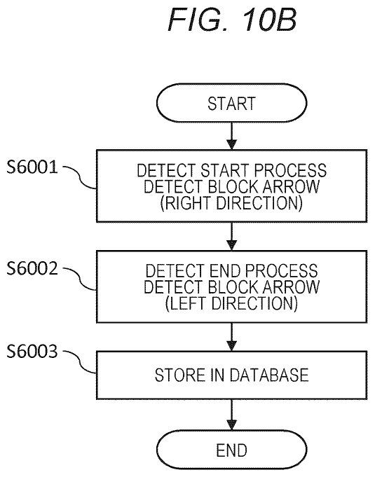

FIG. 10A is an example of an SFC. The SFC includes process start/end blocks, an execution block, and a condition block. The process starts from the start block, executes the process which is set when the execution block is reached, and waits until conditions are met when a condition block is reached. When conditions are met, the processing advances to the next process. When the end block is finally reached, the corresponding process is completed. In FIG. 10A, a start block of a dotted line frame is a start point element, and an end block of a chain line frame is an end point element.

FIG. 10B is a flowchart illustrating a procedure for detecting start-and-end point elements in the SFC and is performed by the start-and-end point element extraction unit 130. First, the right direction of the block arrow is detected to detect the start process (S6001). The block arrow is detected from the fact that two horizontal lines are parallel and the x coordinates of the end points of the horizontal lines coincide with each other, the ends of the horizontal lines being connected by a vertical line while the other ends are connected by two oblique lines. In the case of the start process, detection is performed based on the fact that the ends of the horizontal lines having the smaller x-coordinate are connected by a vertical line while the other ends are connected by two oblique lines. Next, an end process is detected (S6002). Detection of the end process is the same as the detection method for the start process but is based on the fact that the ends of the horizontal lines having the larger x-coordinate are connected by a vertical line while the other ends of the horizontal lines are connected by two oblique lines. Finally, the start process and the end process are registered as the start-and-end point elements 154 in the database 150 (S6003).

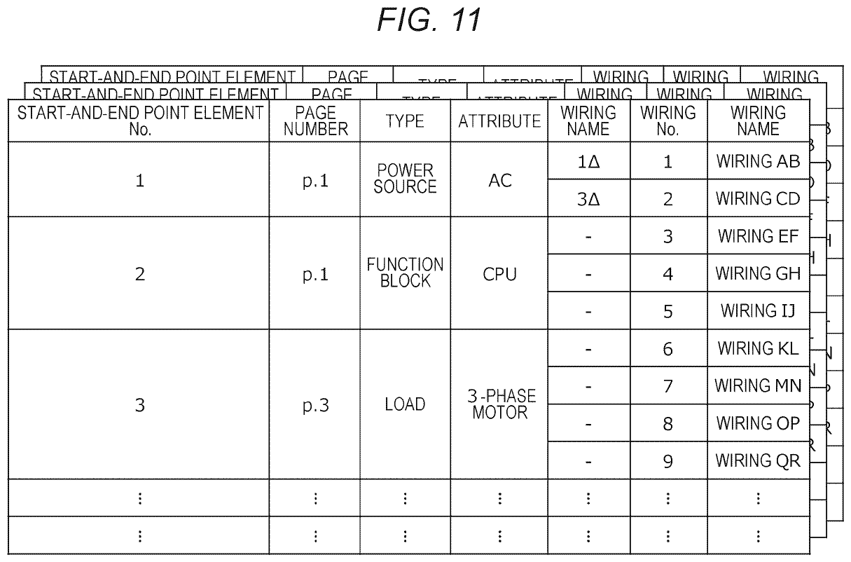

FIG. 11 is a diagram showing a table of the start-and-end point elements 154 in the database 150. The table of the start-and-end point elements 154 includes start-and-end point element Nos. incremented in order of detection, page numbers where the start-and-end point elements are present, types, and attributes, wiring names to be associated with a power source line in the case of a power source, wiring Nos. connected to the start-and-end point elements, and wiring names connected to the start-and-end point elements. For example, in a case where there are four types of drawings such as an elementary wiring diagram, a ladder diagram, an FBD, and an SFC, one table (four tables in total) is registered as the start-and-end point elements 154 for each drawing. In addition to the information illustrated in FIG. 11, the drawing type may be stored for each table, for example.

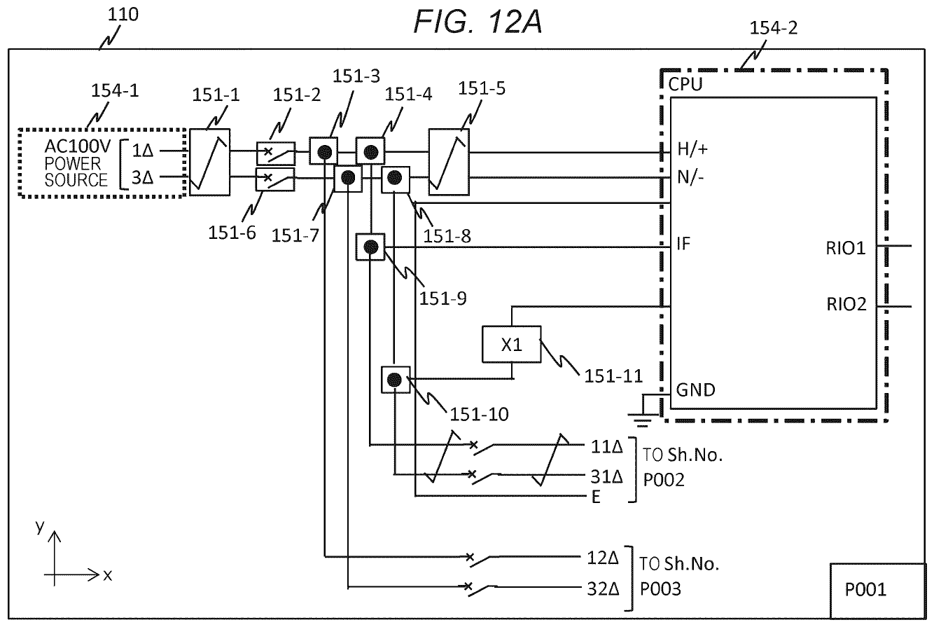

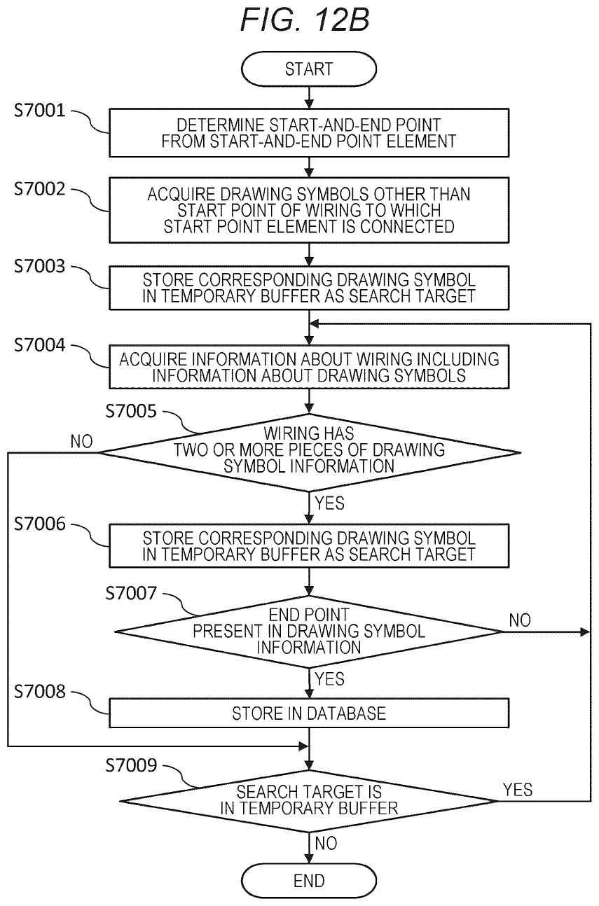

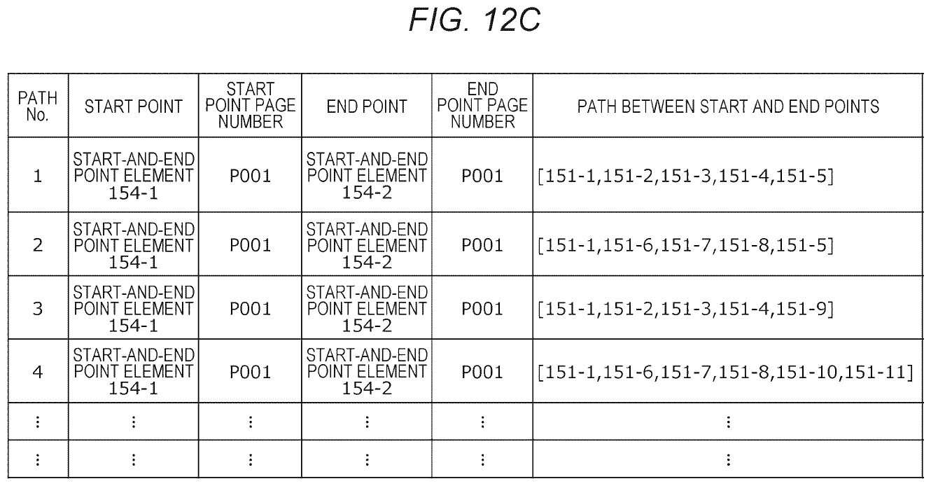

FIGS. 12A to 12C are diagrams illustrating a method for extracting a path between the start and end points. FIG. 12A illustrates an example of extracting a path between a start-and-end point element 154-1 and a start-and-end point element 154-2. FIG. 12B is a flowchart illustrating a path extraction procedure which is performed by the start-and-end point path extraction unit 140. FIG. 12C shows a table of paths 155 between the start-and-end points.

S7001: Determine a start point and an end point among the start-and-end point elements 154. In the drawings describing electrical characteristics, a current often flows from a small x coordinate side to a large x coordinate side and from a large y coordinate side to a small y coordinate side. Therefore, the small x coordinate side and the large y coordinate side are often the start point. In the example of FIG. 12A, because the start-and-end point element 154-1 is disposed on the small x coordinate side, the start-and-end point element 154-1 is determined as the start point and the start-and-end point element 154-2 is determined as the end point. Hereinafter, a description will be provided using the start-and-end point element 154-1 as a start point and the start-and-end point element 154-2 as an end point.

S7002: There are eleven drawing symbols, namely, drawing symbols 151-1 to 151-11, between the start point and the end point. As shown in FIG. 11, the start-and-end point elements have wiring information, and as shown in FIG. 4B, the wiring information carries information on drawing symbols which are to be connected. The drawing symbol 151-1 is obtained by using two pieces of connection information.

Next, the drawing symbol 151-1 is stored in a primary buffer as a search target (S7003), and the wiring connected to the drawing symbol 151-1 is sought from the wiring information of FIG. 4B (S7004). After searching for the wiring having the drawing symbol 151-1 as drawing symbol information, it is determined whether the wiring has two or more pieces of drawing symbol information (S7005). The reason for this determination is that it is indicated that the wiring is an end point in a case where the wiring does not have drawing symbol information other than the drawing symbol 151-1, and thus, in a case where there is no search target in the temporary buffer in step S7009, the search is ended. In the present example, because each of the two pieces of wiring has a drawing symbol 151-2 and a drawing symbol 151-6 which are drawing symbol information other than the drawing symbol 151-1, the information of the drawing symbol 151-2 and the drawing symbol 151-6 is stored as a search target in the primary buffer (S7006). Whether the end point is present is determined as the stored drawing symbol information (S7007), and in a case where the end point is present, the end point is stored in the database (S7008).

As illustrated in FIG. 12C, the database includes a list that includes path Nos, start points, page numbers of the start points, end points, page numbers of the end points, and drawing symbol Nos, which are paths between the start-and-end points. In this example, there are a total of four paths between the start point and the end point. In a case where the end point is not present, the process returns to the step of S7004 to continue the search (S7007: No). In a case where the wiring information has only one piece of drawing symbol information in the middle stage, that is, in a case where the end points of the wiring are open and a connection relationship cannot be generated at the time of determination in S7005, the search for the drawing symbols is ended. In this case, the path between the start point and the end point is not registered. The search is repeated until there is no drawing symbol as a search target in the primary buffer, and a path passing through the drawing symbols 151-1 to 151-11 and connected to the CPU is extracted. The above is a specific extraction method for the start-and-end point path extraction unit.

### <First Embodiment: Summary>

The drawing work support system 100 according to the first embodiment generates information on a connection between wiring and a drawing symbol in a drawing, extracts wiring or a drawing symbol as a start-and-end point element representing a previous start point or end point, discriminates a start point and an end point from the start-and-end point element, and then extracts a path between the start point and the end point. By extracting a connection path between the start point and the end point, the connection path can be regarded as one work unit. Therefore, elements in the drawings can be identified for each work unit performed by the worker, in addition to simply exhaustively extracting connection relationships in the drawings. As a result, progress management or the like for each work unit becomes easier.

### Second Embodiment

A second embodiment of the present invention will describe a configuration example of shortening a path generation time for start and end points spanning multiple pages.

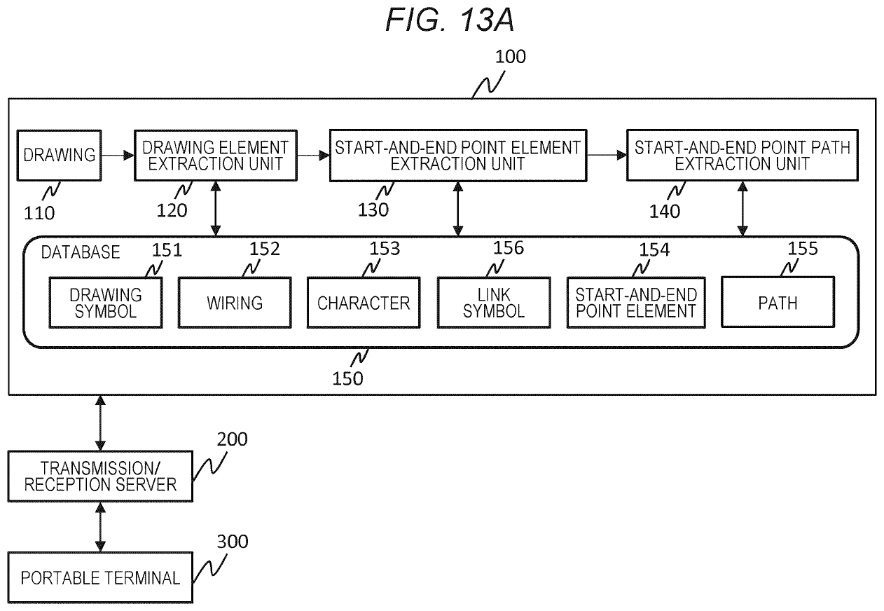

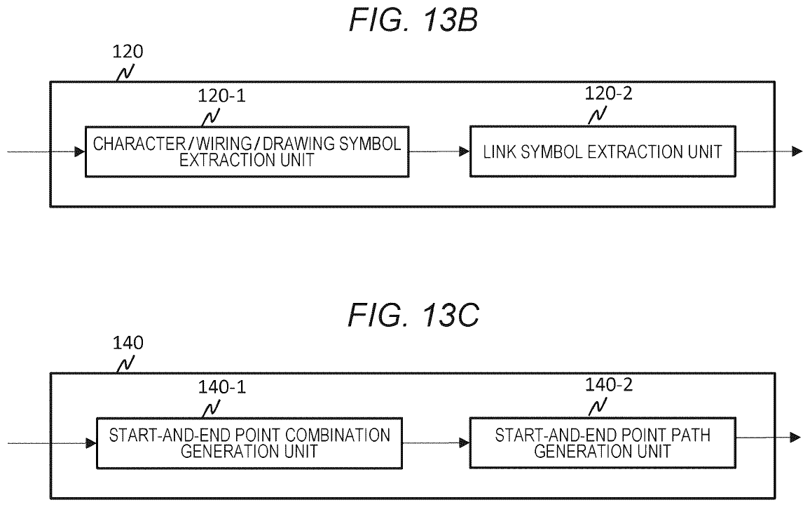

FIGS. 13A to 13C are configuration diagrams of the drawing work support system 100 according to the second embodiment. FIG. 13A is a diagram showing an overall configuration, FIG. 13B is a diagram showing a configuration of a drawing element extraction unit 120, and FIG. 13C is a diagram showing a configuration of a start-and-end point path extraction unit 140.

The present embodiment is different from the first embodiment in that link symbols 156 are added to the database 150, the drawing element extraction unit 120 includes a character/wiring/drawing element extraction unit 120-1 and a link symbol extraction unit 120-2, and the start-and-end point path extraction unit 140 includes a start-and-end point combination generation unit 140-1 and a start-and-end point path generation unit 140-2. Hereinafter, the drawing element extraction units 120 and the start-and-end-point path extraction units 140, which represent of points of revision, will be mainly described.

First, the role of the link symbols in the drawings and the operation of the link symbol extraction unit 120-2 will be described, and then the operation of the start-and-end point path extraction unit 140 using the link symbols will be described.

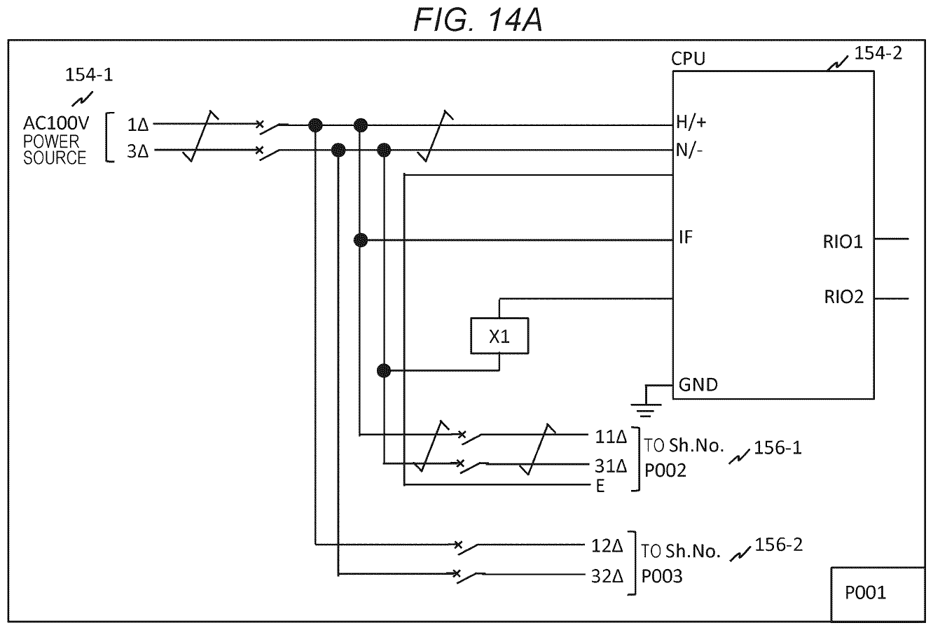

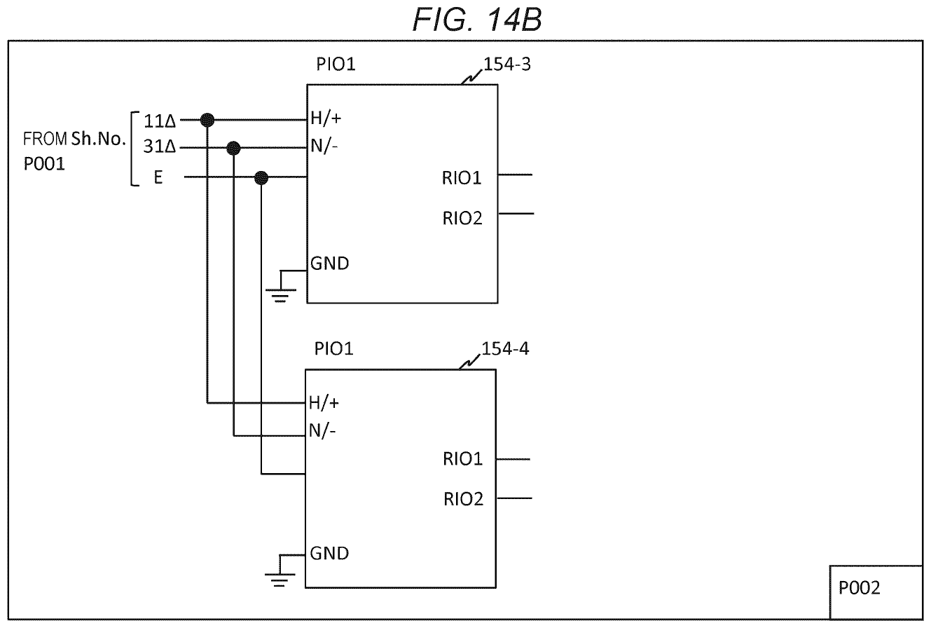

FIGS. 14A to 14B are diagrams showing the roles of link symbols. FIG. 14A illustrates a page where a start point is present, and FIG. 14B illustrates a page where an end point is present. The drawings illustrated in FIGS. 14A to 14B have a two-page configuration of P001 and P002, and link symbols 156-1 and 156-2 are present in P001 and link symbol 156-3 is present in P002. The link symbols are symbols for connecting wires between pages, where the link symbol 156-1 connects P001 and P002, and the link symbol 156-2 connects P001 and P003 across pages. In the examples, link symbols describe links to pages, but may also be unique numbers indicating links to a particular location. For example, a link symbol is a symbol in which a number is surrounded by a circle or a symbol in which an alphabetic character is surrounded by an ellipse. A link symbol is used to generate a path between a start point and an end point across pages. For example, if a path is generated with a start point 154-1 at P001 and an end point 154-3 at P002, the path can be generated by following the link symbol 156-1.

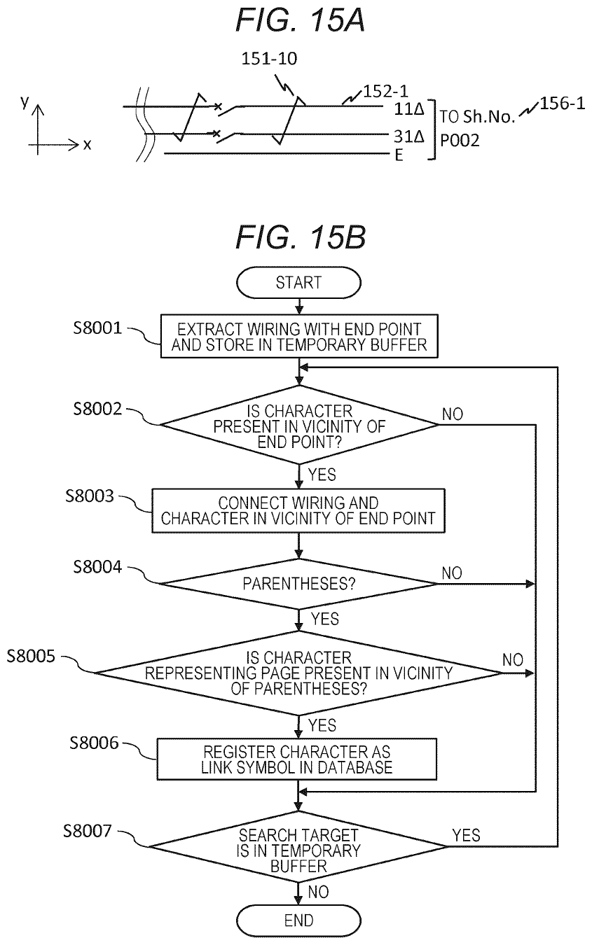

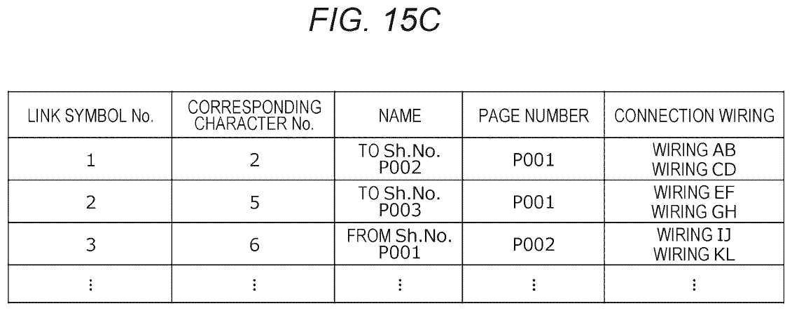

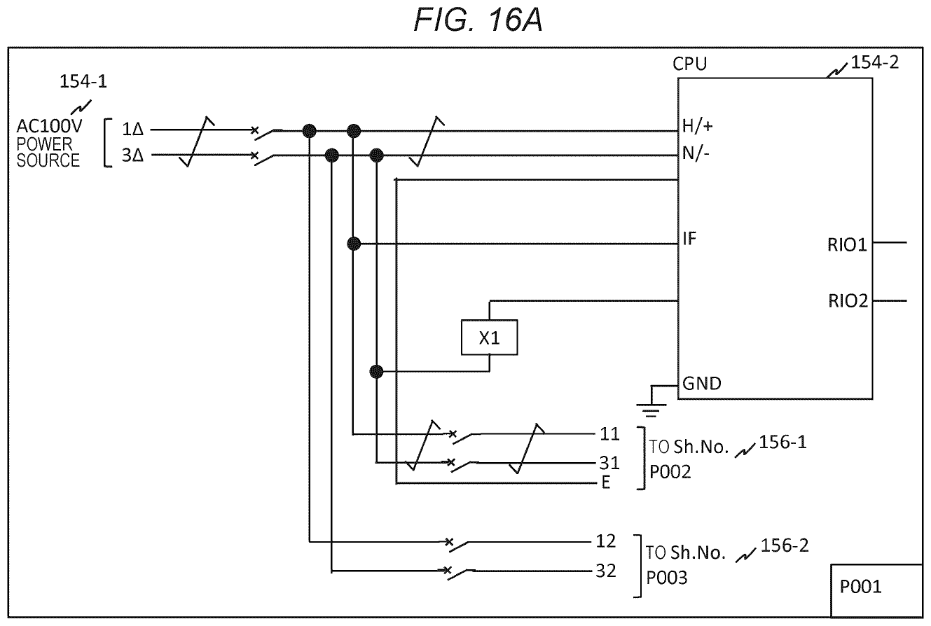

FIGS. 15A to 15C are diagrams illustrating a link symbol extraction method. FIG. 15A is a diagram showing wiring and drawing symbols in the vicinity of link symbols. FIG. 15B is a flowchart illustrating a procedure for extracting link symbols and is performed by the link symbol extraction unit 120-2. FIG. 15C is a diagram showing a database of link symbols 156.

As illustrated in FIG. 15A, link symbol 156-1 is present at the end point of the wiring 152. The end point of the wiring is sought from the wiring 152 in the database 150. At the time of searching, it is possible to determine whether the wiring 152 has an end point by looking at the number of drawing symbols to be connected in the table of FIG. 4B. For example, when wiring No. 2 is viewed, it can be seen that there is only one drawing symbol No. to be connected, and nothing is connected to the coordinate 2 side. Such wiring 152 is extracted, and a link symbol is extracted.

The link symbol extraction unit 120-2 first extracts all the pieces of wiring having end points as described above, and stores the extracted wiring in a temporary buffer in order to search for the link symbols of all the wiring (S8001). Next, a search for characters in the vicinity of the end points is performed (S8002). The search is performed in consideration of the directions of the pieces of wiring 152. In FIG. 15A, the link symbol 156-1 is on the +x direction side of the wiring 152-1, but for example, when the coordinates of the wiring 152-1 are [(200,300), (300,300)] and the drawing symbol No. to be connected is 10 (coordinate 1), it can be seen that the coordinate 2 side is an end point and the link symbol is on the +x direction side of the wiring. Therefore, only the +x direction side is searched. On the other hand, in a case where there is a link symbol on the −x direction side from the information of wiring 152, a search is performed only on the −x direction side. The same applies to the y direction. In a case where, as a result of the search, there are characters in the vicinity of end points, characters 153 in the vicinity of the end points are associated with the corresponding wiring 152 (S8003). The characters 153 in the vicinity of the end points may be associated with corresponding names in the database of the wiring 152, or a new column may be added to store the characters 153 in the vicinity of the end points. In a case where there is no character in the vicinity of the end points, it is determined whether there is search target wiring in the temporary buffer (S8007), and in a case where there is a search target, similar processing is performed on other wiring, and in a case where there is no search target, the processing is terminated. Next, a search for parentheses around characters in the vicinity of the end points is performed (S8004). The parentheses are registered as the characters 153 or registered as the drawing symbols 151, and the processing advances to S8005 in a case where parentheses are present, whereas the processing advances to S8007 in a case where parentheses are not present. Next, a search for characters representing pages in the vicinity of the parentheses is performed (S8005). Examples of characters representing pages include Sh. No., Sheet No., P, and p. In a case where there are characters 153 including such characters representing the pages, the characters 153 are registered in a database as the link symbols 156 (S8006). Next, in S8007, it is determined whether there is a search target in the temporary buffer, and in a case where there is a search target, the processing returns to S8002 and similar processing is performed on the other wiring. In a case where there is no search target, the processing is terminated.

The database of link symbols 156 in FIG. 15C includes link symbol Nos., corresponding character Nos., names, page numbers where the link symbols are present, and wiring corresponding to the link symbols. Link source pages are managed by page numbers, and link destination pages are managed by names.

Next, the operation of the start-and-end point combination generation unit 140-1 using link symbols will be described. In FIG. 11, which is generated by the start-and-end point element extraction unit 130, there are many start-and-end point elements. In the database of FIG. 12C, combination examples in the same page have been described, but many combinations occur in the case of a plurality of pages. However, there are many combinations that are not actually connected as paths, and it is necessary to generate appropriate combinations in the interests of reducing the search time. Therefore, combinations of start and end points are generated using the link symbols.

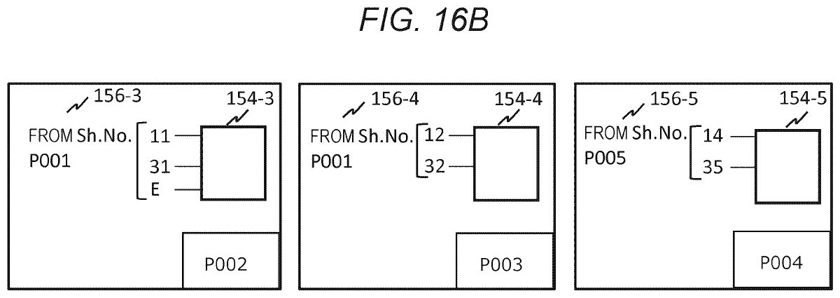

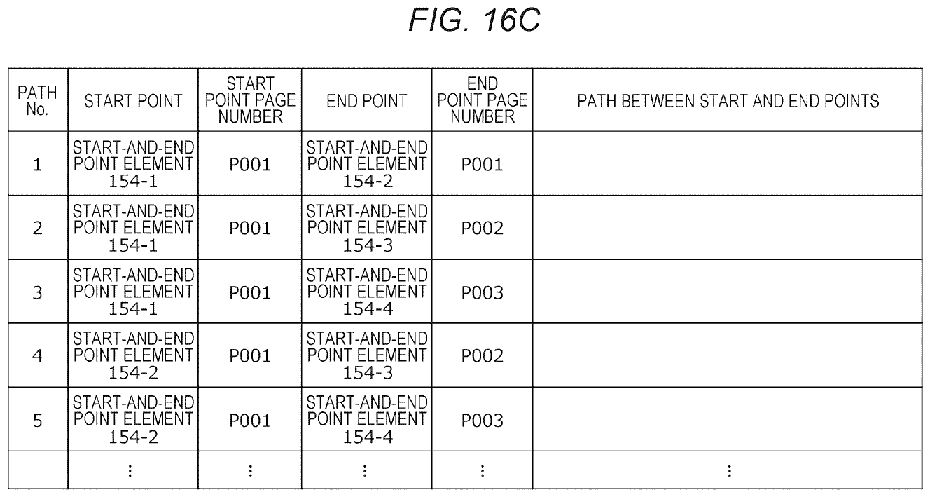

FIGS. 16A to 16C are diagrams illustrating the operation of the start-and-end point combination generation unit 140-1. FIG. 16A shows a page where a start point is present. FIG. 16B shows a page where an end point is present. FIG. 16C shows a database of paths after the generation of start-and-end point combinations. In FIG. 16B, a start-and-end point element 154-3, a start-and-end point element 154-4, and a start-and-end point element 154-5 are arranged in P002, P003, and P004, respectively. A link symbol Sh. No. P001 is present in P002 and P003, and is connected to the start-and-end point element 154-3 and the start-and-end point element 154-4 via the wiring 152. A link symbol 156-5 is present in P004 and is connected to the start-and-end point element 154-5 via wiring 152.

First, combinations are generated by focusing on the start-and-end point elements of P001. The combinations are processed separately for the same page and for another page. First, in the same page, the start-and-end point element 154-1 and the start-and-end point element 154-2 are present and generated as combinations. Next, combination processing with another page is performed. In the combination of the start-and-end point element 154-1 and another page, the start-and-end point elements in P002 and P003, which are pages indicated by the link symbols 156-1 and 156-2, are confirmed. Because the start-and-end point element 154-3 is present in P002 and the start-and-end point element 154-4 is present in P003, combinations of the start-and-end point element 154-1 with the start-and-end point element 154-3 and the start-and-end point element 154-4, respectively, are generated. At this time, because P001 does not have a link to P004, P001 is not generated as a combination, and only the page number indicated by the link symbol 156 present in P001 is searched. By implementing such processing, it is possible to search for paths only for combinations of start and end points for which there is a high possibility of a path being present, without generating an enormous number of combinations of start-and-end point elements present in many pages, which leads to a reduction in search time. Similarly, the start-and-end point element 154-2 present in P001 generates a combination of start and end points using the link symbol 156-1 and the link symbol 156-2. When the combination of P001 is sequentially completed, the processing advances to the generation of combinations of start and end points after P002.

FIG. 16C is a database of paths after the generation of start-and-end point combinations for the start-and-end point elements 154 present in P001. In this example, combinations of start and end points within the page and including other pages are stored. Paths between the start and end points are currently blank because the paths between the start and end points are stored after the processing by the start-and-end point path generation unit 140-2 described below. In addition, it may be determined whether the combinations of start and end points are to be generated to include not only the coordinate relationships but also the types described for the start-and-end point elements 154 illustrated in FIG. 11. The start point/end point combinations have the following five patterns: (1) power source (+) (or power source (−))/function block, (2) function block/function block, (3) power source (+)/GND (or power source (−)), (4) power source/load, and (5) function block/load. Therefore, after the above-described start-and-end point combinations utilizing link symbols are generated, processing to determine whether the combinations fit the five patterns may be included. If, as a result of determining whether the combinations fit the five patterns, the combinations fit, the combinations are stored in the path database of FIG. 16C, and if not, the combinations are not stored in the database.

Next, the operation of the start-and-end point path extraction unit 140 using link symbols will be described. First, a path generation method in which start and end points are on the same page will be described, and next, a path generation method in a case where start and end points are present on different pages will be described.

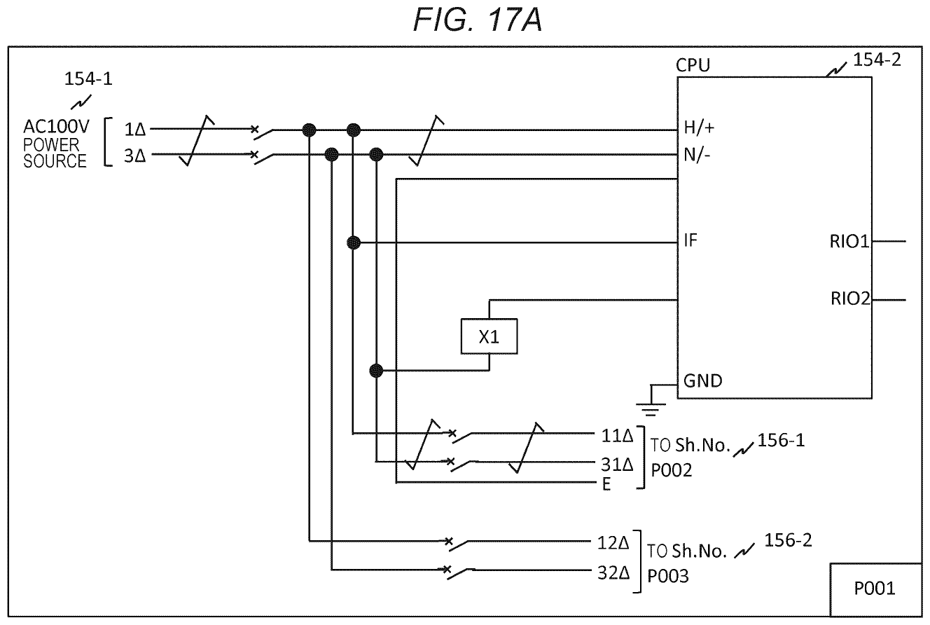

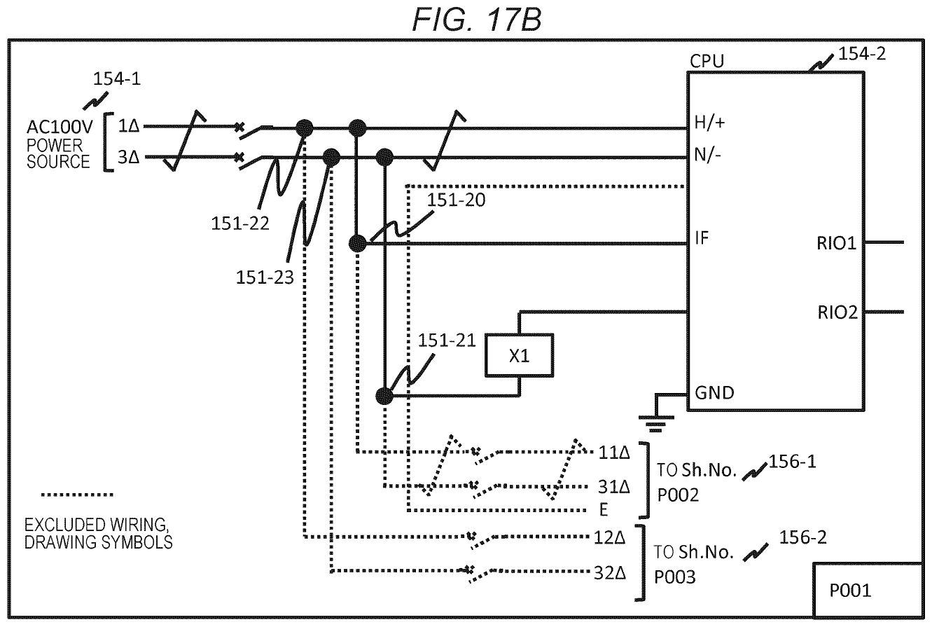

FIGS. 17A to 17B are diagrams illustrating the operation of the start-and-end point path extraction unit 140 in a case where the start and end points are present in the same page. In the case of searching for paths between the start point 154-1 and the end point 154-2, a path search for wiring connected to the link symbol 156-1 and the link symbol 156-2 becomes a futile search because there is no path connecting between the start point 154-1 and the end point 154-2. Therefore, by excluding paths connected to link symbols from the search target, the speed of the path search is increased.

FIG. 17B illustrates a diagram in which the paths connected to link symbols are excluded from the path search targets. The paths excluded from the targets are indicated by dotted lines. The link symbols 156 have information on connections to the wiring 152 in FIG. 15C, and the wiring 152 has information on connections to the drawing symbols 151. Thus, the connection points of the drawing symbols 151-20 to 23 are reached by tracing the wiring connecting the link symbols 156 and the drawing symbols. Because the connection point is described in branch portions of the wiring 152, the wiring 152 leading to the link symbol 156 is excluded by tracing back to the connection point. At this time, the wiring 152 connected to the link symbol 156 is excluded also in a case where not the connection point but rather another block is reached when tracing from the link symbol 156. With such processing, only paths having a high probability of being a path between the start point 154-1 and the end point 154-2 can be searched for, leading to a reduced time.

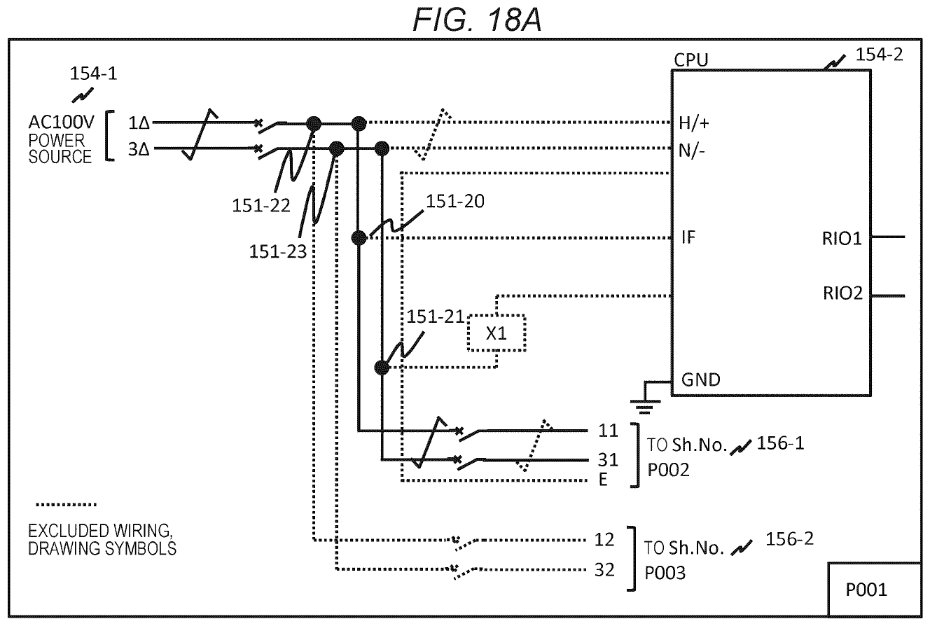

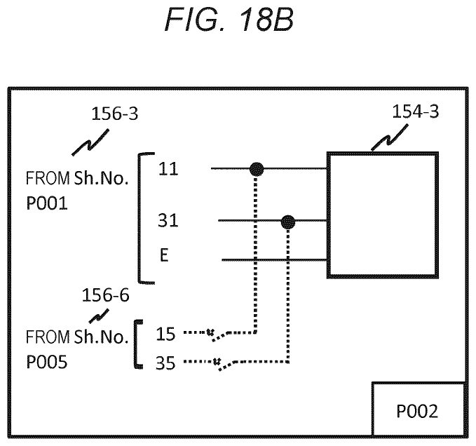

FIGS. 18A to 18B are diagrams illustrating the operation of the start-and-end point path generation unit in a case where the start point and the end point are present on different pages. A start point is present in FIG. 18A, and an end point is present in FIG. 18B. The path generation between the start point and the end point when the start point is 154-1 and the end point is 154-3 will be described as an example.

The combination of the start point and the end point is in the path database of FIG. 16C, the start point 154-1 being present in P001, and the end point 154-3 being present in P002, and hence the link symbol 156-1 connecting P001 and P002 is extracted from FIG. 15C and utilized. Unlike the operation of the start-and-end point path generation unit 140-2 in the same page, only the wiring connected to the link symbol 156-1 is set as the path search target, as illustrated in FIG. 18A. Thus, the wiring 152 connecting to another link symbol 156-2 and to another start-and-end point element 154-2 is excluded together with the drawing symbols 151. The exclusion processing excludes wiring associated with the other link symbol 156-2 and the other start-and-end point element 154-2 by using the method of tracing back to the connection point described above. In addition, in a case where there are other link symbols and start-and-end point elements in P002 where the end point 154-3 is present, these link symbols and start-and-end point elements are similarly excluded. In this way, it is possible to extract paths from the start point 154-1 to the link symbol 156-1 in a short time. From the link symbol 156-1 to the end point 154-3, the matching link symbol 156-3 is searched from the connection wiring illustrated in FIG. 15C and the name in the database of the characters 153 in FIG. 4B of the link symbol 156-1, and paths are searched for by being associated with the wiring 152 in P002.

### Third Embodiment

In a third embodiment of the present invention, a configuration example will be described in which work management can be performed in work units, and an alert or the like at the time of work using the drawings can be displayed.

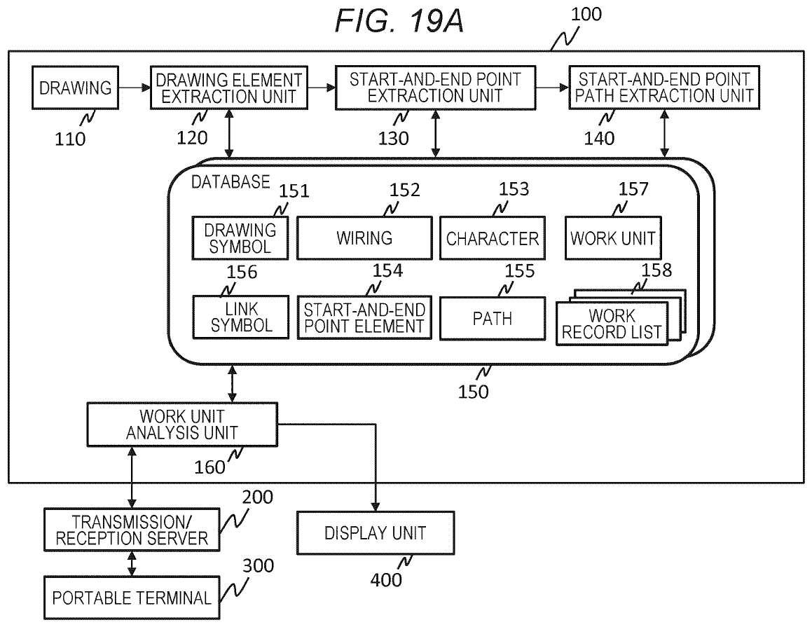

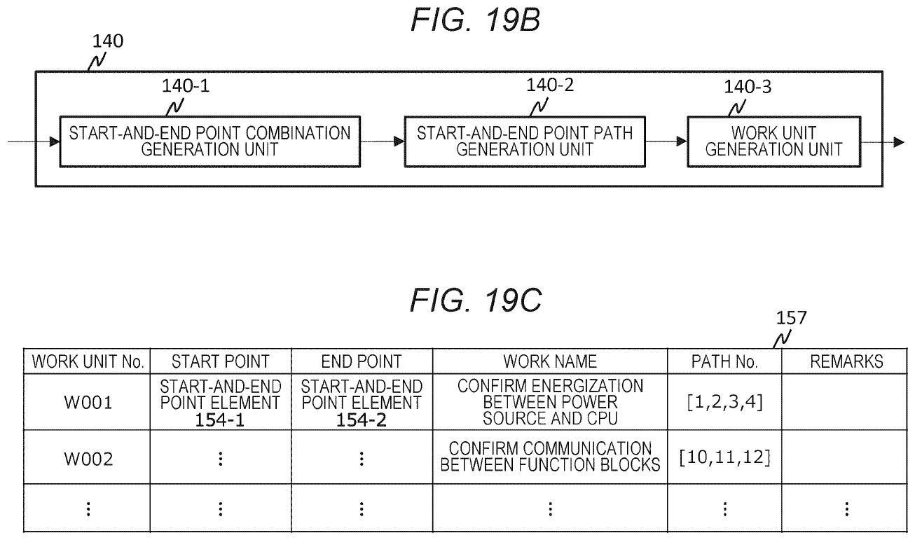

FIGS. 19A to 19C are configuration diagrams of a drawing work support system 100 according to a third embodiment. FIG. 19A shows an overall configuration, FIG. 19B shows a configuration of the start-and-end point path extraction unit 140, and FIG. 19C shows a database of work units 157.

When the third embodiment is compared with the second embodiment, the following are added: (a) a display unit 400; (b) a work unit analysis unit 160 in the drawing work support system 100; (c) work units 157 which are work units of staff at the site in the database 150; a work record list 158 which is a past work record; and (d) a work unit generation unit 140-3 in the start-to-end path extraction unit 140. The work record list 158 includes work units of past drawing work and work records thereof (working time, order, etc).

The path information on the start and end points is output from the start-and-end point path generation unit 140-2. The work unit generation unit 140-3 sets the path information as one work unit for each combination of start and end points, and stores the corresponding path No. in the work unit 157. In addition, because the type of the start point and the end point can be ascertained from the start-and-end point elements 154, the types are output as work names to the work unit 157. For example, in FIG. 11, it can be estimated that the type of the start-and-end point element 154-1 is that of a power source, the type of the start-and-end point element 154-2 is that of a function block, and that the work names are confirmation of energization between the power source and the function block. FIG. 19C shows the result of generating the work unit as described above, and shows an output result of the work unit generation unit 140-3 that has received the path information of FIG. 12C. The work unit 157 includes a work unit No., a start point, an end point, a work name, a path No., and remarks. The work unit analysis unit 160 receives and analyzes the work record of the drawing 110 from the work unit 157 and the work record list 158 in the database 150, and from the portable terminal 300, outputs the result to the display unit 400, and displays the work support content on the portable terminal 300 of the worker via the transmission/reception server 200. In addition, as work units, in the ladder diagram of FIG. 8, the circuit number (0001) on the left side of the circuit surrounded by the left bus and the right bus is set as a work unit, and in the FBD of FIG. 9, four input conditions serving as start points and one function block serving as an end point are set as work units. In addition, in an SFC, the start of process A is taken as a start point and the end of process A is taken as an end point, the start of process A and the end of process A each constituting work units.

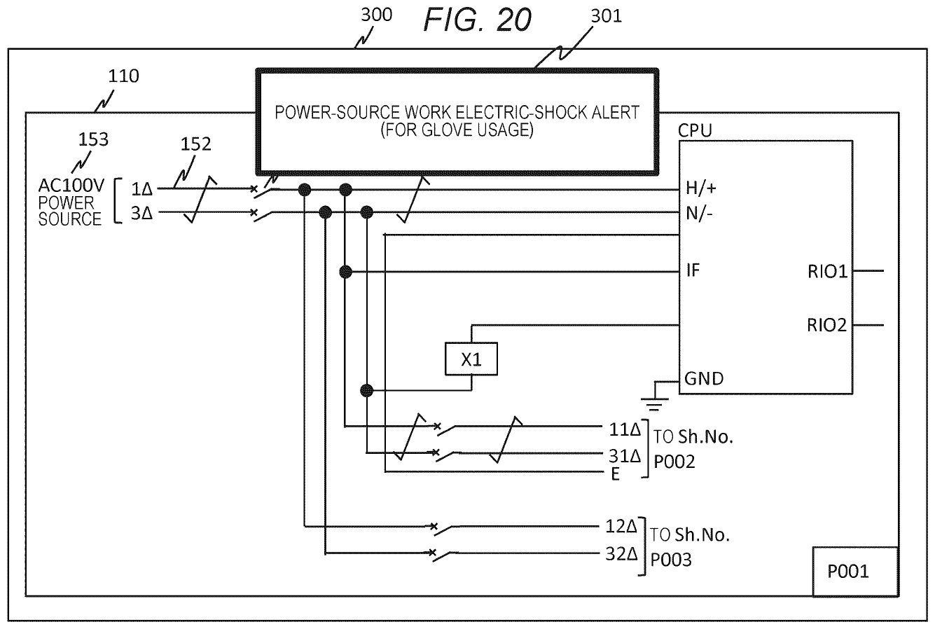

FIG. 20 is a diagram showing an example in which work support content is displayed on the portable terminal 300. In FIG. 20, an alert 301 is displayed according to the work units on the portable terminal 300 of the worker, and as a result of the alert 301, the worker is careful regarding a possible electric shock from the power source and is prompted to wear gloves. This is because the work unit analysis unit 160 estimates that the work is power source work from the work name in the corresponding work unit in the work unit 157 and transmits a display to the portable terminal 300, thereby alerting the worker.

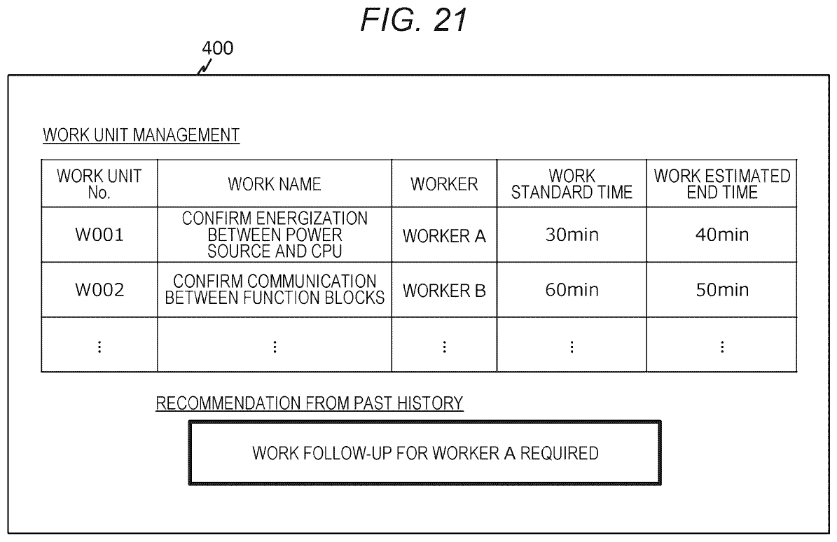

FIG. 21 illustrates an example in which the analysis result of the work unit analysis unit 160 is displayed on the display unit 400. FIG. 21 assumes a screen display on the manager side, and displays who is working on the work unit, how long it takes to complete the work by using the average value of the past similar works from the past work record list 158, and how long it takes to end the work from past similar work by the corresponding worker. Because the similarity between a past work unit and a present work unit varies for characters, depending on the case, the similarity may be calculated depending on how many elements match by using, for example, the coordinate information of the wiring 152 and the drawing symbols 151. If the similarity exceeds, for example, 70%, the drawing can be regarded as a minor change, and the similarity of the work can be regarded as high. In addition, because the work unit No. W001 is likely to be delayed in light of the work unit analysis result, it is possible to know in advance that work follow-up for the worker A is necessary as a recommended item from the past history.

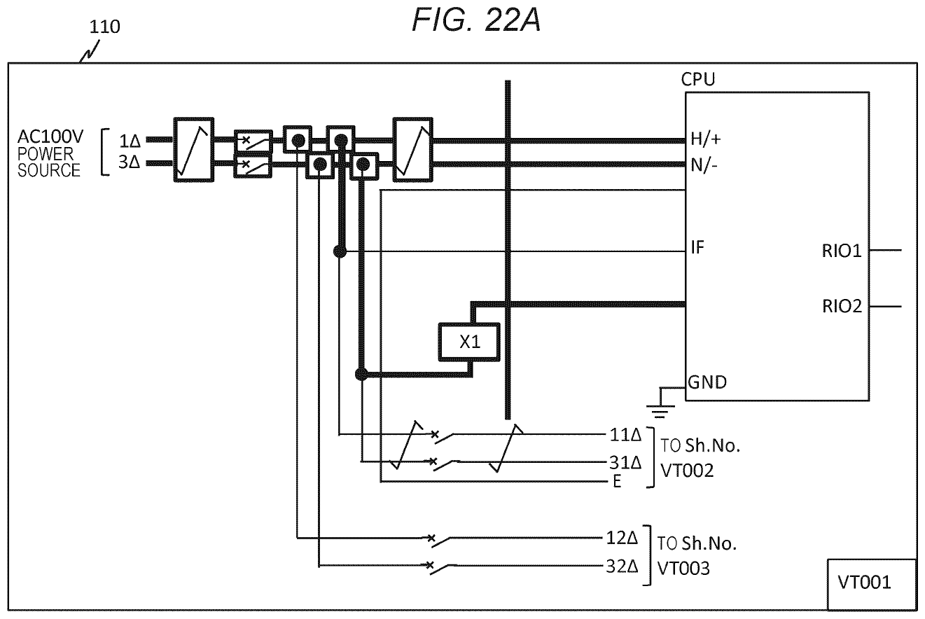

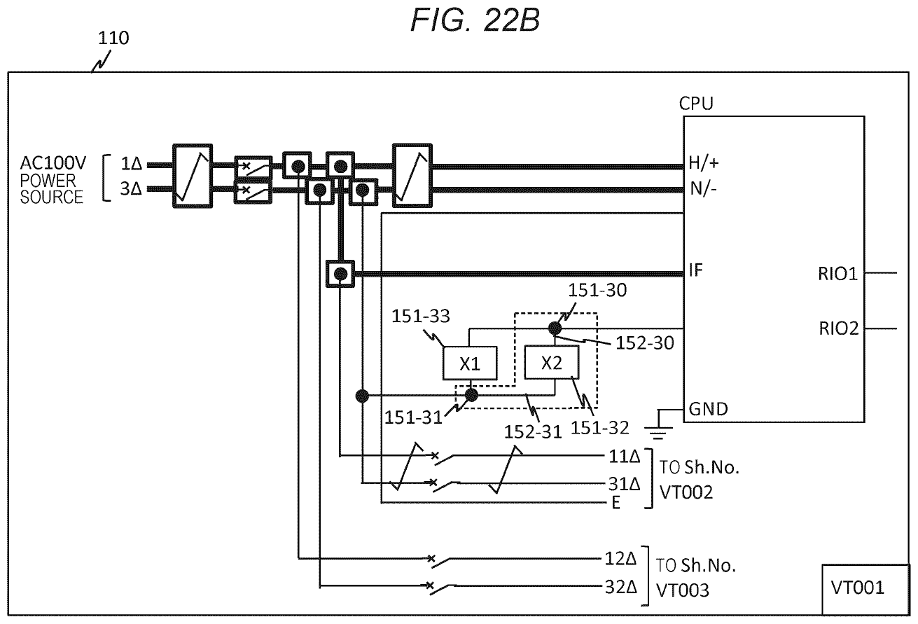

FIGS. 22A to 22B are diagrams showing utilization of work records for a handover function at the time of drawing replacement. An operation of the work record handover function at the time of drawing replacement will be described. The work unit analysis unit 160 first extracts data before and after replacement of the drawing, which is stored in the work unit 157. Thereafter, the coordinates of elements including the drawing symbols 151, the wiring 152, the characters 153, and the link symbols 156 before and after the drawing replacement are compared, and the replaced portion is specified. After the replacement part is specified, the path in the corresponding work unit is specified. In a case where the path is specified, the work record of the path is deleted.

FIG. 22A illustrates a work record before drawing replacement, and FIG. 22B illustrates a work record after drawing replacement. In light of the analysis result from the work unit analysis unit 160, a portion surrounded by a dotted line is a portion added after replacement, and three drawing symbols 151-30, 151-31, and 151-32, the wiring 152-30, and two pieces of wiring 152-31 are added. The drawing symbol 151-33 is the path to which the drawing symbol 151-31 is connected, and the path is changed and thus deleted as a work completion path. In this way, it is possible to grasp some completed paths while utilizing the existing work. In FIG. 22A, the work has been completed for all four paths and the progress is 100% (=4/4 paths), but in FIG. 22B, the progress is 60% (=3/5 paths). By performing management in work unit in this manner, it is possible to manage the progress of the work even at the time of work replacement.

### <Modifications of the Present Invention>

The present invention is not limited to or by the above-described embodiments, and includes various modifications. For example, part of the configuration of one embodiment can be replaced with the configuration of another embodiment, and the configuration of another embodiment can be added to the configuration of the one embodiment, without departing from the gist of the invention. In addition, it is possible to add or eliminate other configurations to/from part of the configuration of each embodiment, or other configurations can be substituted for part of the configuration of each embodiment.

In the above embodiments, link source pages/link destination pages via the link symbols can be distinguished, for example, by regarding a page having a smaller page number as a link source page and regarding a page having a larger page number as a link destination page.

In the above embodiments, each functional unit (the drawing element extraction unit 120, the start-and-end point element extraction unit 130, and the start-and-end point path extraction unit 140) included in the drawing work support system 100 can be configured by hardware such as a circuit device in which these functions are installed or can be configured by an arithmetic device such as a central processing unit (CPU) executing software with which these functions are implemented.

What is claimed is:

1. A drawing work support system that supports work on a drawing, the system comprising:
a drawing element extraction unit that extracts at least any of wiring, a drawing symbol, and a character from the drawing and generates connection information indicating a connection between the wiring and the drawing symbol;
a start-and-end point extraction unit that extracts the wiring or the drawing symbol as a start-and-end point element representing a start point or an end point of the connection on the basis of the character, the wiring, or the drawing symbol; and
a start-and-end point path extraction unit that discriminates the start point and the end point from the start-and-end point element and extracts a path between the start point and the end point.

2. The drawing work support system according to claim 1, wherein, in a case where the drawing is a ladder diagram, the start-and-end point extraction unit extracts a left bus of the ladder diagram and a right bus of the ladder diagram, respectively, and
wherein, among circuit elements sandwiched between the left bus and the right bus, the start-and-end point extraction unit extracts a contact point connected to the left bus as the start-and-end point element and extracts an element connected to the right bus as the start-and-end point element.

3. The drawing work support system according to claim 1, wherein, in a case where the drawing is a function block diagram (FBD), the start-and-end point extraction unit extracts an input element in the FBD and a function block in the FBD, and
wherein the start-and-end point extraction unit extracts the function block as the start-and-end point element and extracts the input element as the start-and-end point element.

4. The drawing work support system according to claim 1, wherein, in a case where the drawing is a sequential function chart (SFC), the start-and-end point extraction unit extracts a start process in the SFC and an end process in the SFC, and
wherein the start-and-end point extraction unit extracts the start process as the start-and-end point element and extracts the end process as the start-and-end point element.

5. The drawing work support system according to claim 1, wherein the start-and-end point path extraction unit discriminates, in a path formed by two of the start-and-end point elements, the start-and-end point element having a smaller x coordinate and a larger y coordinate in the drawing as the start point, and discriminates the other start-and-end point element as the end point.

6. The drawing work support system according to claim 1, wherein the drawing element extraction unit extracts a link symbol linking between an element included in a first page of the drawing and an element included in a second page of the drawing, and
wherein, in a case where the first page and the second page are linked by the link symbol, the start-and-end point path extraction unit extracts the start point and the end point spanning the path intersecting the first page and the second page.

7. The drawing work support system according to claim 6, wherein, in a case where two of the start-and-end point elements are present in the same page, the start-and-end point path extraction unit extracts the path by using one of the two start-and-end point elements as the start point and the other of the two start-and-end point elements as the end point, and
wherein, in a case where the start-and-end point element present in the first page and the start-and-end point element present in the second page are linked by the link symbol, the start-and-end point path extraction unit extracts the start-and-end point element present on a link source side of the link symbol as the start point and extracts the start-and-end point element present on a link destination side as the end point.

8. The drawing work support system according to claim 6, wherein the drawing element extraction unit extracts, as the link symbol, a character string representing a page in the drawing from among character strings within a predetermined distance from an open end which is not connected to another element, among the ends of the wiring.

9. The drawing work support system according to claim 1, wherein the start-and-end point extraction unit specifies whether the drawing symbol is any of a power source, a function block, and a load, and
wherein the start-and-end point extraction unit extracts, as a combination of the start point and the end point forming the path, only any of:
the power source and the function block,
the function block and the function block;
the power source and the power source,
the power source and the load, and
the function block and the load.

10. The drawing work support system according to claim 6, wherein, in a case where a search is performed determining whether or not the path is formed between elements present in the same page, the start-and-end point path extraction unit excludes, from search targets, the start-and-end point element, the wiring, and the drawing symbol connected to the link symbol in a link source page of the link symbol, and the start-and-end point element, the wiring, and the drawing symbol connected to the link symbol in a link destination page of the link symbol.

11. The drawing work support system according to claim 6, wherein, in a case where a search for the paths intersecting the first page and the second page is performed, the start-and-end point path extraction unit excludes the start-and-end point element, the drawing, and the wiring that are not connected to the link symbol on the first page from search targets, and excludes the start-and-end point element, the drawing, and the wiring that are not connected to the link symbol on the second page from the search targets.

12. The drawing work support system according to claim 1, wherein the start-and-end point path extraction unit records the path formed by the start point and the end point as a work unit of the work.

13. The drawing work support system according to claim 12,
wherein the drawing work support system further comprises a work unit analysis unit that specifies a portion, of the work unit, which is replaced after the path is specified, and
wherein, for the work unit which includes the portion changed by the replacement in the path, the work unit analysis unit deletes a record of the work performed before the replacement.

14. The drawing work support system according to claim 12,
wherein the drawing work support system further comprises a work unit analysis unit that analyzes whether a power source is included in the work unit, and
wherein, in a case where a power source is included in the work unit, the work unit analysis unit transmits an alert to a terminal used by a worker at the time the worker is to work on the work unit.

15. The drawing work support system according to claim 12,
wherein the drawing work support system further comprises a work unit analysis unit that presents at least either of a standard time of the work unit and a man-hour estimation of the work unit.
